(19) United States
(12) Patent Application Publication
(10) Pub. No.: US 2026/0046412 A1
(43) Pub. Date: Feb. 12, 2026

(54) LIDAR POINT-CLOUD COMPRESSION WITH SPARSE RANGE IMAGES

(71) Applicant: Tencent America LLC, Palo Alto, CA (US)

(72) Inventor: Stephan WENGER, Hillsborough, CA (US)

(73) Assignee: Tencent America LLC, Palo Alto, CA (US)

(21) Appl. No.: 19/268,899

(22) Filed: Jul. 14, 2025

Related U.S. Application Data
(60) Provisional application No. 63/680,552, filed on Aug. 7, 2024.
(60) Provisional application No. 63/695,749, filed on Sep. 17, 2024.
(60) Provisional application No. 63/708,123, filed on Oct. 16, 2024.
(60) Provisional application No. 63/708,665, filed on Oct. 17, 2024.
(60) Provisional application No. 63/710,540, filed on Oct. 22, 2024.

(51) Int. Cl. H04N 19/136; H04N 19/124; H04N 19/132; H04N 19/147; H04N 19/182; H04N 19/70

(52) U.S. Cl. CPC H04N 19/136; H04N 19/124; H04N 19/132; H04N 19/147; H04N 19/182; H04N 19/70

(57) ABSTRACT

A bitstream including coded information of a three-dimensional (3D) point cloud is received. The 3D point cloud includes a plurality of points in a 3D space. The bitstream is parsed into a first sub-bitstream associated with an occupancy map and a second sub-bitstream associated with a sparse range image (SRI) in a two-dimensional (2D) space. The SRI is converted from the 3D point cloud in the 3D space. The occupancy map indicates whether one of a plurality of samples of the SRI has a corresponding point in the 3D point cloud. The occupancy map is determined based on the first sub-bitstream and the SRI based on the second sub-bitstream. The 3D point cloud is reconstructed based on the SRI and the occupancy map.

### INCORPORATION BY REFERENCE

The present application claims the benefit of priority to U.S. Provisional Application No. 63/680,552, “LIDAR POINT-CLOUD COMPRESSION WITH SPARSE RANGE IMAGES” filed on Aug. 7, 2024, U.S. Provisional Application No. 63/695,749, “LIDAR POINT-CLOUD COMPRESSION WITH MULTIPLE SPARSE RANGE IMAGES” filed on Sep. 17, 2024, U.S. Provisional Application No. 63/708,123, “LIDAR POINT-CLOUD COMPRESSION USING UNPROJECTED POINT LIST” filed on Oct. 16, 2024, U.S. Provisional Application No. 63/708,665, “LIDAR POINT-CLOUD COMPRESSION USING VERTICAL BAND QUANTIZATION” filed on Oct. 17, 2024, and U.S. Provisional Application No. 63/710,540, “LIDAR POINT-CLOUD COMPRESSION USING PROJECTION BASED ON SIDE INFORMATION” filed on Oct. 22, 2024. The entire disclosures of the prior applications are hereby incorporated by reference in their entirety.

### TECHNICAL FIELD

The present disclosure describes aspects generally related to LiDAR point-cloud compression.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

MPEG has published point cloud compression standards including the V-PCC standard, suited primarily for dense point clouds and the G-PCC standard (ISO-IEC 23090-9), which targets sparse point clouds. As LiDAR-generated point clouds tend to be sparse, V-PCC is considered less suitable for the compression of the LiDAR-generated point clouds. G-PCC was designed with the compression of sparse point clouds, including the LiDAR-generated point clouds. However, the G-PCC (e.g., the octree-based approach in its second edition) may not provide sufficient compression efficiency for the computational demands of some LiDAR-based applications. Accordingly, improved point cloud coding techniques that may benefit from artificial intelligence-based approaches are needed.

### SUMMARY

Aspects of the disclosure include bitstreams, methods, and apparatuses for point cloud encoding/decoding. In some examples, an apparatus for point cloud encoding/decoding includes processing circuitry.

According to an aspect of the disclosure, a method of point cloud decoding is provided. In the method, a bitstream including coded information of a three-dimensional (3D) point cloud is received. The 3D point cloud includes a plurality of points in a 3D space. The bitstream is parsed into a first sub-bitstream associated with an occupancy map and a second sub-bitstream associated with a sparse range image (SRI) in a two-dimensional (2D) space. The SRI is converted from the 3D point cloud in the 3D space. The occupancy map indicates whether one of a plurality of samples of the SRI has a corresponding point in the 3D point cloud. The occupancy map is determined based on the first sub-bitstream and the SRI based on the second sub-bitstream. The 3D point cloud is reconstructed based on the SRI and the occupancy map.

According to another aspect of the disclosure, a method of point cloud encoding is provided. In the method, a 3D point cloud that includes a plurality of points in a 3D space is converted into a SRI in a 2D space. An occupancy map is determined from the SRI. The occupancy map indicates whether one of a plurality of samples in the SRI has a corresponding point in the 3D point cloud. The SRI is packed based on occupancy information of the occupancy map to obtain a packed SRI. The packed SRI does not include one or more unoccupied samples of the SRI that do not have corresponding points in the 3D point cloud. One or more unoccupied samples of the packed SRI are filled to obtain a filled SRI based on neighboring occupied samples of the packed SRI. The occupancy map is encoded into a first sub-bitstream of a bitstream and the filled SRI is encoded into a second sub-bitstream of the bitstream.

According to yet another aspect of the disclosure, a non-transitory computer-readable storage medium storing a bitstream that is generated by an encoding method is provided. In the encoding method, a 3D point cloud that includes a plurality of points in a 3D space is converted into a SRI in a 2D space. An occupancy map is determined from the SRI. The occupancy map indicates whether one of a plurality of samples in the SRI has a corresponding point in the 3D point cloud. The SRI is packed based on occupancy information of the occupancy map to obtain a packed SRI. The packed SRI does not include one or more unoccupied samples of the SRI that do not have corresponding points in the 3D point cloud. One or more unoccupied samples of the packed SRI are filled to obtain a filled SRI based on neighboring occupied samples of the packed SRI. The occupancy map is encoded into a first sub-bitstream of a bitstream and the filled SRI is encoded into a second sub-bitstream of the bitstream.

Aspects of the disclosure also provide an apparatus for point cloud decoding/encoding. The apparatus for point cloud decoding/encoding including processing circuitry configured to implement any of the described methods for point cloud decoding/encoding.

Technical solutions of the disclosure include methods and apparatuses to compress sparse point clouds. In some aspects, the sparse point clouds are compressed based on a generated 2D representation of a point cloud and application of one or more cascading modules. A reasonable balance between compression efficiency and computational complexity is gained based on the disclosed methods. In an example, a 3D point cloud that includes a plurality of points in a 3D space is converted into an SRI in a 2D space. An occupancy map is determined from the SRI. The occupancy map indicates whether one of a plurality of samples in the SRI has a corresponding point in the 3D point cloud. The SRI is packed based on occupancy information of the occupancy map to obtain a packed SRI. The packed SRI does not include one or more unoccupied samples of the SRI that do not have corresponding points in the 3D point cloud. One or more unoccupied samples of the packed SRI are filled to obtain a filled SRI based on neighboring occupied samples of the packed SRI. The occupancy map is encoded into a first sub-bitstream of a bitstream and the filled SRI is encoded into a second sub-bitstream of the bitstream. Thus, based on the generated 2D representation of the point cloud and the application of the one or more cascading modules, the sparse point clouds are compressed, and a balance between compression efficiency and computational complexity can be gained.

### BRIEF DESCRIPTION OF THE DRAWINGS

Further features, the nature, and various advantages of the disclosed subject matter will be more apparent from the following detailed description and the accompanying drawings in which:

FIG. 1 is an example of an illustration of a sparse three-dimensional (3D) point cloud that is rendered into a two-dimensional (2D) space.

FIG. 2 is a schematic illustration of an example of an encoder and a decoder in accordance with some aspects of the disclosure.

FIG. 3 is a schematic illustration of an example of a conversion of a 3D point cloud into a 2D image.

FIG. 4 is a schematic illustration of an example of a point selection of a 3D point cloud based on rho (r) values.

FIG. 5 is a schematic illustration of an example of categorization of a 3D point cloud using theta angles.

FIG. 6 is a schematic illustration of an example of an encoder in accordance with some aspects of the disclosure.

FIG. 7 is a schematic illustration of an example of an encoder in accordance with some aspects of the disclosure.

FIG. 8 is a schematic illustration of an example of a flow chart to generate a unprojected point list associated with a 3D point cloud.

FIG. 9 is a schematic illustration of an example of a 3D point cloud that is rendered in a 2D polar coordinate system.

FIG. 10 is a schematic illustration of an example of a division of the 3D point cloud that is rendered in the 2D polar coordinate system.

FIG. 11 is a schematic illustration of an example of a corrected error in a 2D image representation of a 3D point cloud.

FIG. 12 shows a flow chart outlining a decoding process according to some aspects of the disclosure.

FIG. 13 shows a flow chart outlining an encoding process according to some aspects of the disclosure.

FIG. 14 is a schematic illustration of a computer system in accordance with an aspect.

### DETAILED DESCRIPTION

Aspects of the disclosure include techniques for encoding and decoding three-dimensional (3D) point clouds, such as LiDAR point-clouds. The encoding process may involve generating a two-dimensional (2D) representation of a point cloud, and application of one or more cascading modules that may produce a bitstream. The decoding process may reverse the steps in the encoding process, resulting in converting the decoded 2D representation of the point cloud back into a 3D point-cloud.

Compression of sparse point clouds, such as points clouds generated from LiDAR devices, poses a challenge. For example, related techniques may not offer a reasonable balance between compression efficiency and computational complexity.

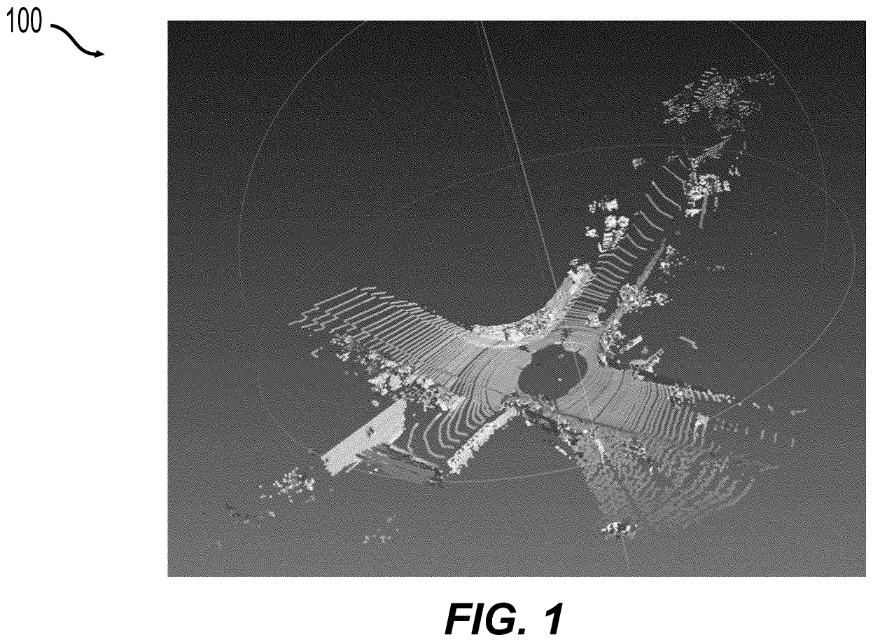

An example of a LiDAR obtained point cloud is provided in FIG. 1. As shown in FIG. 1, a 3D point cloud generated by a LiDAR device is rendered into a 2D image (100).

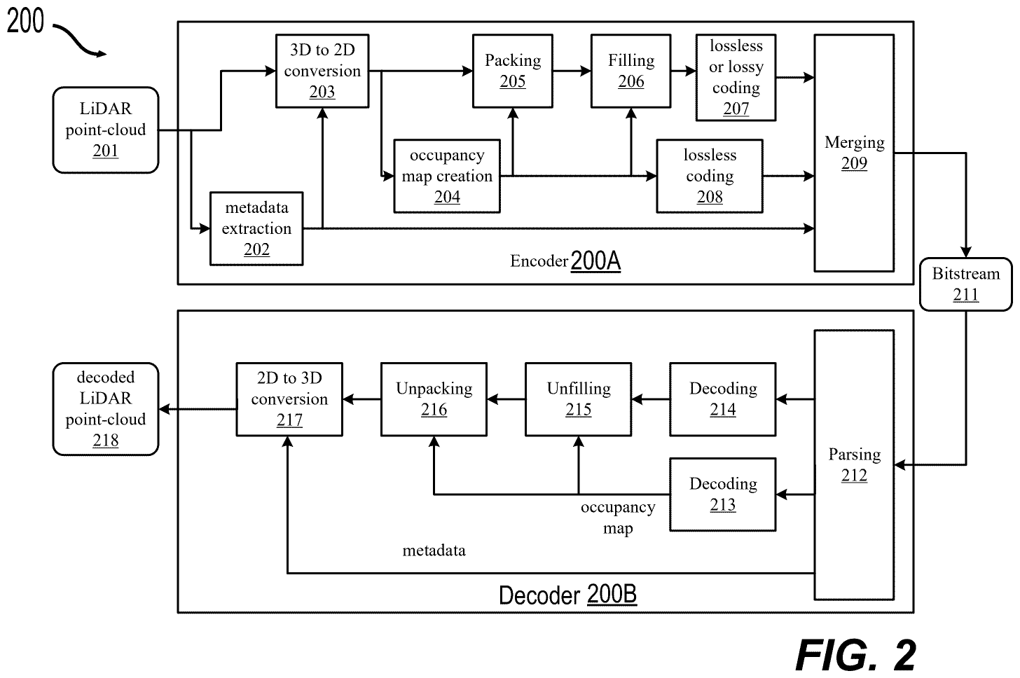

FIG. 2 shows an example of a process (200) to encode and decode a 3D point cloud (201) based on an encoder (200A) and a decoder (200B) respectively. Aspects of the disclosure include compression of a LiDAR-obtained, uncompressed, point-cloud represented signal (201) into a bitstream (211), and an inverse decoding process resulting in a decompressed point cloud (218). An example of a LiDAR obtained point cloud data set is shown in FIG. 1.

As shown in FIG. 2, the decoding process may be bit-exact. For example, decoding a given bitstream (e.g., the bitstream (211)) may result in identical point clouds (218) regardless of details of the decoder implementation. The encoding process may be specified in ways that are not bit-exact. The LiDAR-obtained point cloud (201) may be compressed into the bitstream (211) by converting (203) the 3D point cloud (201) into a 2D representation (e.g., a sparsely populated 2D image), such as by a converting component of the encoder (200A). An occupancy map (204) may be generated, such as by a generating component of the encoder (200A). The occupancy map may be coded using a coding mode, such as a loss-less coding (208). The occupancy map may be available to a bitstream merger/generator (209). The occupancy map may be used to pack (205) the sparsely populated 2D image into a smaller 2D image (e.g., a densely populated 2D image) that is more densely populated. In an example, the sparsely populated 2D image is packed by a packing component of the encoder (200A) to remove certain samples that have no corresponding points in the 3D point cloud. The densely populated 2D image may still include samples with values that are not defined by the conversion/packing. The densely populated 2D image may be filled (206) in with adequate sample values to improve the efficiency of the subsequent image coding (207). In an example, the densely populated 2D image may be filled in with interpolated sample values by a filling component of the encoder (200A). The image coding (207) operated by an image encoder (or an encoding component of the encoder (200A)) may use traditional or novel (e.g., AI-based) coding techniques. An output of the image encoder may be made available to the merger/generator (209) which creates the bitstream (211), possibly including extracted metadata (202).

The decoding may follow an inverse technique. The bitstream (211) may be parsed and entropy-decoded (212), such as by a decoding component of the decoder (200B), into symbols or sub-bitstreams. The symbols or sub-bitstream may pertain to, for example, a sparsely coded image, an occupancy map, and metadata. The sparsely coded image may be decoded (214), such as by a decoding component of the decoder (200B), to obtain a filled image. The filled image may be un-filled (215), such as by an unfilling component of the decoder (200B), to obtain an unfilled image. The unfilled image may mark sample values not indicated by the occupancy map as unused. The unfilled image may further be unpacked (216), such as by an unpacking component of the decoder (200B), to create a sparsely coded image. The unfilling (215) and unpacking (216) steps may employ information from the occupancy map which is available after decoding (213). The sparsely populated 2D images may be converted, such as by a converting component of the decoder (200B), to a 3D representation (217) which may result in a reconstructed point cloud (218).

A basic outline of the conversion from the 3D point cloud (or 3D point cloud sample values) to 2D image (203), referred to herein as a sparse range image or SRI, may employ spherical coordinate mapping. A point in a 3D point cloud may be converted from Cartesian coordinates (x, y, z) to spherical coordinates (r, θ, ϕ), where r (rho) is a distance from a LiDAR sensor to the point, θ (theta) is an azimuth angle, ϕ (phi) is an elevation angle. The spherical coordinates may be mapped onto a 2D image plane. For example, a horizontal axis of the 2D image may represent the azimuth angle θ, a vertical axis of the 2D image may represent the elevation angle ϕ. Each pixel (or sample) in the 2D image may be assigned a value corresponding to the distance r of a nearest point (to the sensor) that maps to the pixel. If multiple points project to the same pixel, a point with a smallest range may be chosen, capturing a nearest surface of the 3D point cloud. A resolution of the 2D image may be determined by an angular resolution of the LiDAR sensor. Scaling factors (e.g., horizontal scaling and/or vertical scaling) may be considered to either increase or decrease the resolution. A field of view of the LiDAR sensor may define an extent of the angles covered in the 2D image. Increasing the horizontal scaling factor and/or vertical scaling factor may increase a size of the images, precision of the angle values (θ, ϕ) reconstructed in the decoding process, and precision of the decoded 3D points accordingly.

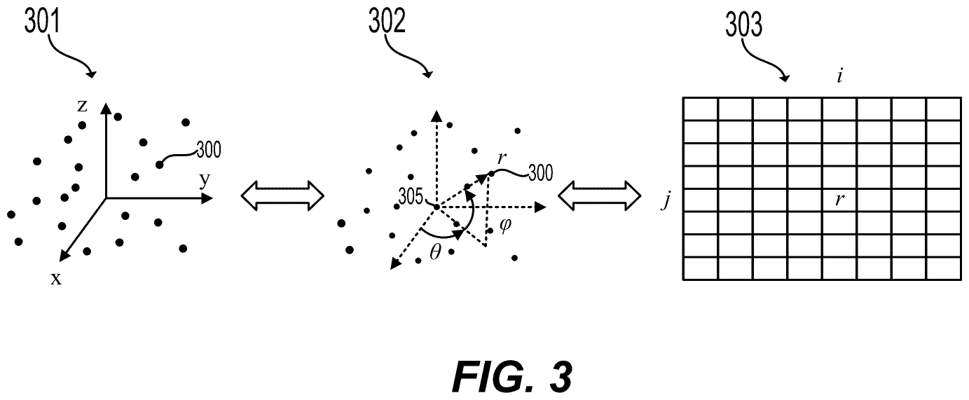

FIG. 3 is an example of conversion of a point (300) in a 3D point cloud from Cartesian coordinates (x, y, z) (301) to spherical coordinates (r, θ, ϕ) (302). As shown in FIG. 3, r (rho) is a distance from a coordinate origin (305) to the point (300), θ (theta) is an azimuth angle, ϕ (phi) is an elevation angle. The spherical coordinates may be mapped onto a 2D image plane (303). As shown in FIG. 3, a horizontal axis of the 2D image representing the azimuth angle θ may be quantized to a horizontal index i, and a vertical axis of the 2D image (303) representing the elevation angle ϕ may be quantized to a vertical index j. Each pixel (or sample) in the 2D image (303) is assigned a value corresponding to a distance r of a nearest point that maps to the pixel. In an example of FIG. 3, the distance r of the point (300) is mapped to the pixel (or pixel position) that corresponds to the azimuth angle θ and the elevation angle ϕ of the point (300).

Still referring to FIG. 2, creation of the occupancy map (204) may be advantageous because the 2D image (or 2D images) resulting from the previously described conversion (203) may be inherently sparse. Due to the scaling factors, a much higher resolution may be required, which may exceed resolution capabilities of related 2D image codecs. An occupancy map, which may have a same size as the SRI, can use a binary representation to indicate whether a point (e.g., a point in the 3D point cloud) has been projected at a given location (e.g., a pixel position in the SRI). Each point (e.g., a point in the 3D point cloud) in the occupancy map may signify (or indicate) whether a corresponding point (or sample or pixel) exists (1) or does not exist (0) in the spare range image. If the SRI does not present any disturbances brought by subsequent processes (e.g., the packing (205) and/or the filling (206)), the occupancy map may be redundant because the occupancy map may not add significant information. In such cases, the occupancy map may be omitted from the bitstream (211) and replaced by an indication that no occupancy is included. A missing occupancy map, as referred by the indication in the bitstream, may indicate that all points (or samples or pixels) in the SRI have relevance, and are equivalent to a coded occupancy map with all values set to 1.

Packing (205) the SRI using the created occupancy map (204) may involve reorganizing data in the SRI to utilize storage more efficiently by focusing on the occupied points. Using the occupancy map, which samples in the 2D image have corresponding points can be determined. A packed image may be created to include more values from the occupied points (or occupied samples or occupied pixels) and fewer values from the unoccupied points. Various packing algorithms may be applied. For example, occupied pixels may be moved at the beginning of each row or column, occupied pixels may be moved in a raster order, or in a z-scan order, etc. In an aspect of the disclosure, packing may not be required or advantageous. For example, if the SRI is already dense, the packing operation can be as simple as using the unmodified SRI (e.g., the original SRI) as the packed SRI.

Packing (205) may reduce the size of the packed SRI relative to the original SRI by excluding the empty, unoccupied points.

To ensure that the 2D image is unpacked at the decoder without loss detrimental to the functionality of the overall system, the occupancy map may be advantageously coded (208) in loss-less. In an example, the occupancy map may be coded by loss-less profiles of HEVC or VVC. In an example, the occupancy map may be represented in a one-dimensional signal, and encoded using a zip coding, a run length coding, a context-adaptive binary arithmetic coding (CABAC), etc.

To increase the efficiency of the image encoder, the unoccupied samples of the packed SRI may be filled (206) with sample data adequate for the design of the image coding mechanism used. In an example, the sample data filled into an unoccupied sample may be based on values of neighboring samples. For example, the unoccupied sample may be filled by copying the value of the closest occupied sample in a scan order. In an example, the unoccupied sample may be filled by more complex padding algorithms, such as seed fill, row and column fill, push/pull, and reverse intra prediction based on the intra prediction technique employed by the image codec, etc. The filling (206) may be executed independently regardless of whether the SRI has been packed or not.

Compression of the packed SRI (207) may involve known compression techniques including zip, HEVC, VVC, or neural encoding approaches.

The bitstream (211) format may include, among other items, one or more of (i) the coded (after packing and filling) SRI image bitstream; (ii) a bitstream representing the coded occupancy map; and (iii) metadata coded in a suitable format, for example in the form of one or more supplementary enhancement information (SEI) messages, a possibly compressed XML document, or the like. Metadata may be extracted (202) from the source point cloud (201) and may be used to steer (or control) certain decoding steps, for example the 2D to 3D conversion (217). Metadata may be extracted as an output by the decoder (200B) in a suitable format to control rendering (not depicted). Metadata may serve certain purposes. In an example, the 2D image resolution depends on the angle covered by the LiDAR. In an example, the elevation angle is needed to set the vertical resolution of the 2D image. In an example, the min and max of the elevation angle, for which a point can be found, may be signalled in the metadata.

The decoder (200B) may perform steps that are characterized as an inverse of the encoder steps described above. A first step of the decoder (200B) is to parse (212) the bitstream (211), such as via demultiplexer of the decoder (200B), to extract sub-bitstreams for the packed/filled SRI and the occupancy map, along with the metadata respectively. The sub-bitstream (or second sub-bitstream) of the packed/filled SRI may be decoded (214), such as by a first decoding component of the decoder (200B) using a suitable decoding technology responsive to the bitstream format as created by the encoder (207). Similarly, the sub-bitstream (or first sub-bitstream) with the coded occupancy map may be decoded (213), such as by a second decoding component of the decoder (200B) using an appropriate decoding technique. Outputs of the decoding (214) and the decoding (213) may be used by unfilling (215) and unpacking (216) mechanisms (or steps) that operate on the decoded SRI and the decoded/unfilled SRI, respectively. For example, the second sub-bitstream is decoded to obtain a processed image, where the processed image is generated by packing (205) and filling (206) the SRI. The processed image may be unfilled, via an unfilling component of the decoder (200B), to obtain an unfilled image based on occupancy information of the occupancy map. The unfilled image may be unpacked, via an unpacking component of the decoder (200B), to obtain the SRI based on the occupancy information of the occupancy map. The resulting SRI may be converted (217) back into a point cloud, which may take advantage of metadata conveyed in the bitstream (211).

Depending on capture systems that record the 3D point clouds (201), resolutions of the SRI and the occupancy map, different processing that could have disturbed the data, capabilities of the encoding and decoding machines, and/or expectation of users in terms of quality and bandwidth used, aspects of the disclosure include various implementations.

In an example, for low-power systems, and low-quality and low-bitrate scenarios, an approach without a large-scale image factor may be utilized. In such a case, both the occupancy and the SRI may remain relatively small and may be encoded directly without a packing step.

In an example, for high quality scenarios, large horizontal and vertical scaling factors may be utilized to ensure higher precision on the (θ, ϕ) coordinates. In such a case, the occupancy map may be large and more sparse. To maintain a sparse range image that is easy to encode, a packing process may be performed. A lossless configuration of the encoder (e.g., video encoder) may be used to maintain high quality on the (r) values.

Aspects of the disclosure include techniques for encoding and decoding 3D point clouds, for example LiDAR point-clouds. The encoding process may involve generating a 2D representation of the 3D point cloud, and application of one or more cascading modules that may produce a bitstream. The decoding process may reverse these steps, to convert the decoded 2D representation back into a 3D point-cloud. A point cloud may be represented, among other data, by a suitably coded occupancy map and a plurality of coded 2D images representing packed and filled point cloud sample values, where the sparsely populated 3D image may be subdivided (or categorized) into a plurality of 3D images according to categories, such as a distance of a point cloud sample from a pre-defined point in the 3D space.

Compression of sparse point clouds, for example point clouds stemming from LiDAR devices, poses a challenge because related techniques may not offer a reasonable balance between compression efficiency and computational complexity. The sparsity of a 2D image of point cloud sample values created by geometric projection of the 3D point cloud may pose a challenge when such an image is compressed. Further, positional accuracy for points may be more or less relevant depending on their distances from a given point in space, such as a LiDAR sensor. Efficient techniques are needed to manage the trade-off between coding efficiency and the aforementioned relevance.

Still referring to FIG. 2, in an aspect, the occupancy map may be used to pack (205) the sparsely populated 2D image into a plurality of smaller 2D images that are more densely populated. The densely populated 2D images may still include samples with values not defined by the conversion/packing. The densely populated 2D images may be filled (206) in with interpolated sample values to improve the efficiency of the subsequent image coding (207). A 2D image for packing a sample value can be selected based on criteria, such as a distance of the sample from a given point (e.g., the LiDAR sensor) in a space.

The decoding may follow an inverse technique. In an example, the bitstream (211) may be parsed and entropy-decoded (212) into symbols or sub-bitstreams pertaining to, for example, a plurality of 2D images representing a sparsely coded image representative of point cloud sample values, an occupancy map, and metadata. The plurality of 2D images may be decoded (214), un-filled (215) to mark sample values not indicated by the occupancy map as unused, and unpacked (216) to create a sparsely coded image. The unfilling (215) and unpacking (216) steps may employ information from the occupancy map which is available after the decoding (213). The sparsely populated 2D images may be converted to a 3D representation (217) which may result in the reconstructed point cloud (218).

One challenge with the aforementioned mapping is that a distance r of a point cloud sample from a pre-determined point, such as a position of the LiDAR sensor in a space, is coded as a sample value. Depending on a bit depth of an image codec in use, the distance r is limited to 2^{sample depth}. In an example, 256 distances correspond to an 8 bit sample depth, 1024 distances correspond to a 10 bit sample depth, and so forth. A resulting quantization error of the distance r may be high, which may prevent efficient use of the reconstructed point cloud.

In an aspect, the r value is suitably scaled such that the sample value range, determined by the image coder settings, is utilized in a full range of the sample value range. In an aspect, a sample with a highest r value may be assigned a maximum value allowed by the 2D image coder's bit depth constraint. In an example, if the image codec uses 10 bit samples, a 3D sample with a largest distance (or highest r value) may be assigned as 2¹⁰−1=1023. r values of remaining samples in the point cloud may be represented by samples values that is smaller and linearly scaled, taking the maximum distance r (e.g., 1023) into account.

In an aspect, a non-linear scale for the r parameter is utilized. For example, the quantization could involve the logarithm of r, thereby reducing the quantization error and increasing the accuracy of the representation of r. The smaller r is, the closer the point cloud sample is to the sensor. The non-linear scale may be appropriate for applications that require high precision for points close to the sensor, and less precision for points farther away from the sensor.

In an aspect, other scales may be used that could be optimized for certain application environments. In an aspect, a LiDAR equipment may be optimized for obtaining results in a certain range category. An example is a LiDAR range finder that is optimized for ranges between 300 feet and 1000 feet. In such a scenario, emphasis could be given to r values between 300 and 1000 feet, with a few outlier sample values indicative of larger or closer distances. Such a mapping could be implemented through linear mapping at different scales for r values between 0 . . . 300, 300 . . . 1000, and 1000 . . . max, where max is a maximum phase delay that the LiDAR algorithm provides for.

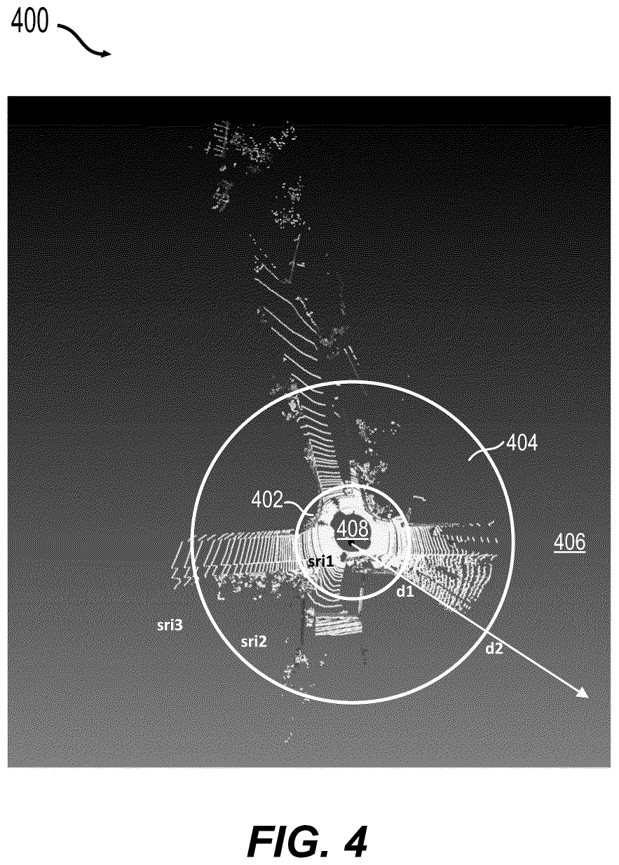

FIG. 4 is a schematic illustration of a point selection of a 3D point cloud based on rho (r) values. As shown in FIG. 4, a 3D point cloud generated by a LiDAR device is rendered into a 2D image (400). According to the range categories, the 2D image (400) can be categorized into three regions (or scales) (402), (404), and (406). The region (402) is defined by a distance range between the original point (408) and d1, the region (404) is defined by a distance range between d1 and d2, and the region (406) is defined by a distance range that is larger than d2. A linear or non-linear scaling may be performed on the distances of the samples in each region.

In an aspect, the aforementioned mapping of the 3D point cloud sample values to 2D representations may involve a plurality of 2D images.

In some cases, a bit depth of a 2D image codec may be limited, even after the aforementioned mapping, to accurately represent distance (r) values of the input point cloud without significant quantization error. Bit depths in image codecs may be restricted by codec design (e.g., 8, 10, or 12 bits). Practical implementation constraints may further limit the bit depth availability. For example, while syntax of some image and video coding standards support up to 16 bit depth, practical hardware implementations in the form of chipsets may only be available in 8 or 10 bit variants. Such a situation may partially be addressed by categorizing r sample values into different categories, and coding the sample of each category into a respective 2D image. Using the aforementioned example of the LiDAR range finder, a first 2D image may be used to represent points closer than 100 feet to the sensor, a second 2D image may be used to represent points between 300 and 1000 feet to a center (e.g., the position of the LiDAR sensor), and a third 2D image may be used for points further than 1000 feet from the center. Aspects of the disclosure include any number of categories and resulting 2D images. The number of categories/images may be determined by factors including application requirements, number of available decoders, and so forth.

The mapping of individual r values within each 2D image may follow a linear or non-linear scale, including the scales described above.

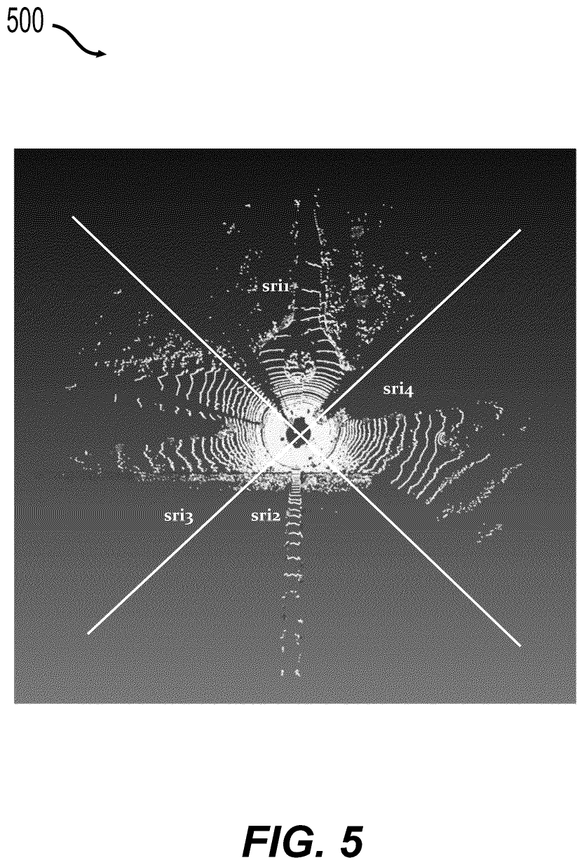

In an aspect, categorization of the samples into multiple 2D images can also be employed using values other than the distance (r) from the center. FIG. 5 shows categorization of a 3D point cloud (500) generated by a LiDAR device based on azimuth angles θ (theta) (or t values). As shown in FIGS. 5, 360 degrees of view of a sensor may be subdivided into four equally spaced areas with t values between 0 and 90 degrees, between 90 and 180 degrees, between 180 and 270 degrees, and between 270 and 360 degrees. Scaling described above may also be applied to the elevation angles ϕ. When using azimuth or elevation for categorization, the 2D image representation may cover certain directions as viewed from the sensor. For example, if the sensor was mounted on a car, conceivably, the 2D image representing an angle range of a driving direction of the car may be most relevant, an angle range of a rear of the car may be less relevant, and an angle range of sides of the car may be relevant only under certain circumstances or for certain purposes, such as collision avoidance or lane changes. Further, sensible angle ranges may also differ based on a speed of the car. Insofar, categories of angles can advantageously be chosen by applications and may be adaptive based on parameters such as speed.

In an aspect of the disclosure, combinations of value ranges of the three dimensions of the spherical coordinate system (e.g., distance, azimuth angle θ, and elevation angle ϕ) are also possible. For example, eight 2D images may be created according to a following combination: two azimuth ranges such as front/back of the sensor, two elevation rages such as upper/lower part of the view, and three different distances, leading to 2×2×3=8 different categories and resulting in eight 2D images.

In an aspect, categorization as described above for the SRI can also be applied to the occupancy map.

Aspects of the disclosure include techniques for encoding and decoding 3D point clouds, for example LiDAR point-clouds. The encoding process may involve generating one or more 2D representations of a 3D point cloud. Transformation from the 3D point cloud into one or more 2D representations may lead to information loss when multiple points of the point cloud project onto a same sample in the 2D representation (e.g., the range image). To mitigate the information loss, techniques are required for creating and encoding (in the encoder), and decoding (in the decoder) a list of unprojected points.

Compression of sparse point clouds, such as point clouds stemming from LiDAR devices, poses a challenge because related techniques may not offer a reasonable balance between compression efficiency and computational complexity. The sparsity of a 2D image of point cloud sample values created by geometric projection of the 3D point cloud may pose a challenge when such an image is compressed. When sparsity of a 2D image is removed through scaling, larger scaling factors increase the likelihood of multiple point cloud samples projecting to a single sample in the 2D representation. Thus, techniques are required to address such as situation.

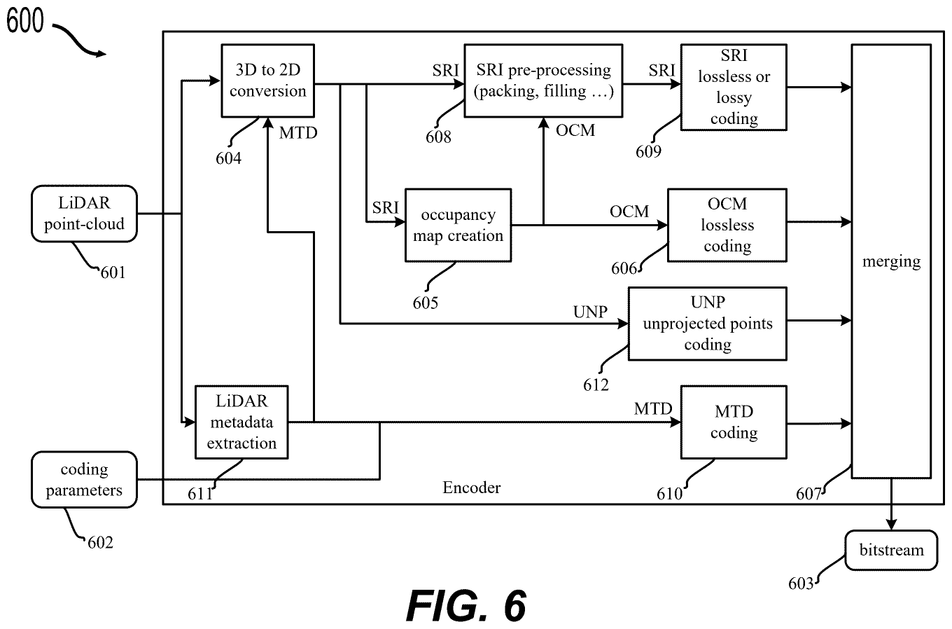

FIG. 6 shows an encoder (600) to compress (or encode) a LiDAR-obtained, uncompressed, point-cloud represented signal (601), in some examples with associated coding parameters (602) such as sensor location/angles/inclination, into a bitstream (603). Referring again to FIG. 6, while a decoding process may be bit-exact in that decoding a given bitstream (603) may result in identical point clouds regardless of the details of the decoder implementation, the encoding process in FIG. 6 may be specified in ways that are not bit-exact. A LiDAR-obtained point cloud (601) may be compressed into a bitstream (603) by converting (604) the 3D point cloud (601) into a 2D representation known as sparse range image (SRI). An occupancy map (OCM) may be generated (605) and coded using, for example, loss-less coding (606), and made available to a bitstream merger/generator (607). The occupancy map may be used to pack (608) the sparsely populated 2D image into a plurality of smaller 2D images that are more densely populated. Those densely populated 2D images may still include samples with values not defined by the conversion/packing, and may be filled in with interpolated sample values to improve the efficiency of the subsequent image coding (609). The 2D image for packing a sample value may be selected based on criteria like the distance of the sample from a given point (e.g., the LiDAR sensor) in a space. The image encoder (609) may use traditional or novel (e.g., AI-based) coding techniques. An output of the image encoder may be available to the merger/generator (607) which creates the bitstream (603), including extracted metadata (611). From the input point cloud (601), after a suitable extraction (611), as well as from the coding parameter source (602), input metadata (MTD) may be received, after appropriate metadata coding (610), as an input to the merger (607) to form in the bitstream (603). Finally, the 3D to 2D conversion process (604) may result in points of the point cloud that are not represented in the sparse range image. Information pertaining to those unprojected points (UNP) may be forwarded to the unprojected points coder (612). After coding, the unprojected points may be sent to the merging (607) to form the bitstream (603).

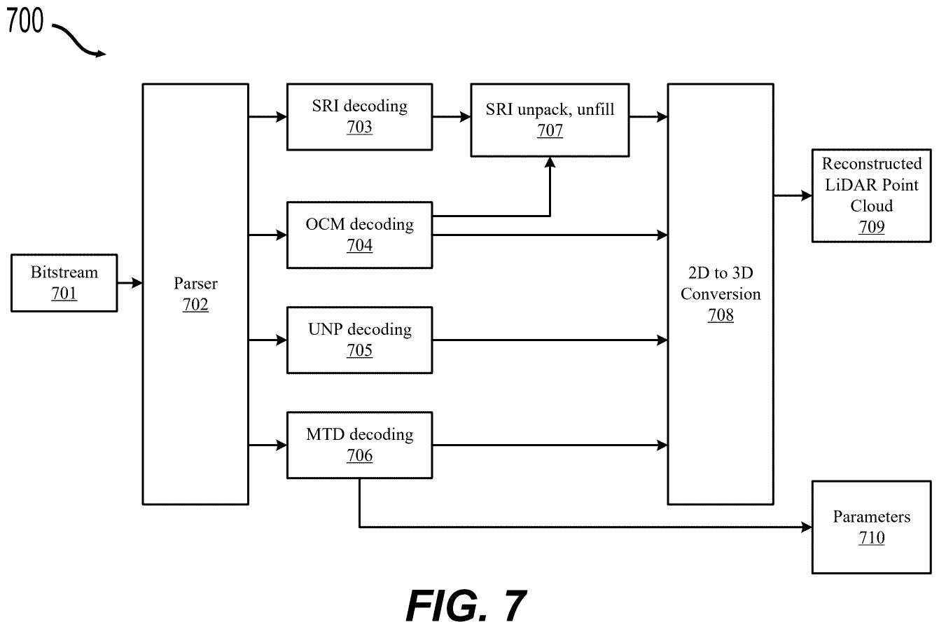

Referring to FIG. 7, the decoding may follow an inverse technique. For example, the bitstream (701) may be parsed and entropy-decoded (702) into symbols or sub-bitstreams pertaining to, for example, an 2D image representing a sparsely coded image (SRI) representative of point cloud sample values, an occupancy map, unprojected point data, and metadata. The 2D image may be decoded (703), un-filled to mark sample values not indicated by the occupancy map as unused, and unpacked (707) to create a sparsely populated image as one input to the 2D to 3D conversion (708). The unfilling and unpacking steps (707) may employ information from the occupancy map which may be available after the decoding of the coded occupancy map (704). An output of the unfilling and unpacking steps (707) may also be an input to the 2D to 3D conversion (708). The parser (702) may also parse information pertaining to unprojected codepoints (UNP) that may be decoded (705) and are further input to the 2D to 3D conversion (708). Further, all aforementioned data is converted (708) into a point cloud and output as a reconstructed point cloud (709). Finally, any coding parameters and other metadata included in the bitstream (701) may be decoded (706) and output as parameters (710) in a suitable format outside the point cloud.

When converting (604) a 3D point cloud (601) onto a 2D range image (SRI), each point may be assigned to a specific pixel in the SRI based on spatial coordinates of the point in three-dimensional point cloud space. However, due to the projection from three dimensions to two dimensions, multiple points may correspond to a same pixel, such as in dense or complex scenes. Such an overlap may present two challenges as follows:
Data Loss: Since only one point may occupy a pixel in the range image (SRI). Without mitigation, additional points, by the math of the conversion process, may populate (or fill) the same pixel. The additional points may not be coded, which may lead to loss of information.
Occlusion: Points representing occluded, or behind-surface details may be lost, affecting the accuracy of depth and structural representation.

In an aspect of the disclosure, unprojected points may refer to points that are not directly assigned to the range image without causing data loss or misrepresentation.

In an aspect, when more than one conflicting point in the point cloud map to the same pixel (e.g., corresponding to the same horizontal axis θ and the same vertical axis ϕ) in the SRI, the SRI may be populated (or filled) by a closest point to a pre-defined point in space, for example an origin of the coordinate system (e.g., a position of the LiDAR sensor). Additional data outside of the SRI, namely a list of unprojected code points, may be used to collect information of such points that are not represented in the SRI to improve the completeness and accuracy of 3D reconstructions.

In an aspect, for points in the source point cloud, a depth value (e.g., a distance to the sensor) of the point is computed. The depth values may be used to classify whether a given point in the point cloud is represented in the SRI or in the unprojected point list.

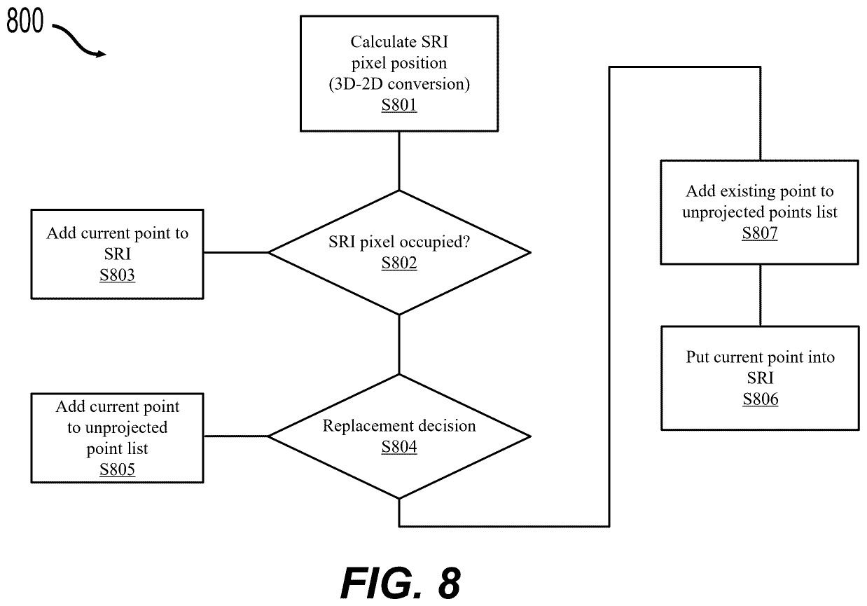

FIG. 8 shows an example of a process flow (800) to generate an unprojected point list associated with a 3D point cloud. As shown in FIG. 8, initially, all pixels (or samples) of the SRI are set to a value indicative of “unoccupied”or “empty”. In an example, that value is 0.

Let a “current point” be a point in the point cloud currently processed. A pixel position in the SRI for the current point can be calculated by the 2D to 3D projection techniques (e.g., convert from Cartesian coordinate to spherical coordinate according to FIG. 3) at (S801).

Based on the calculated pixel position, if the pixel position in the SRI has a value indicative of unoccupied according to (S802), then the current point is assigned directly to the pixel position at (S803). In other words, the depth value of the current point is stored as a pixel value in the SRI range image.

If the pixel position in the SRI is already occupied according to (S802), the process proceeds to (S804) to determine if a current pixel in the pixel position of the SRI may either be replaced, and the current pixel may be put into the unoccupied pixel list, or the current pixel may remain unchanged and the current point of the 3D point cloud is put in the unoccupied pixel list. The determination in (S804) may be driven by application demands, content adaptivity, or the like.

In an aspect, points closer to the LidAR sensor are coded in the SRI, whereas points farther way may be added to the unprojected points list. If the current pixel occupying the pixel position has a lesser depth (e.g., closer to the sensor), replacing the current pixel in the SRI with the current point (farther away) in the 3D point cloud may result in losing foreground information. Therefore, the SRI remains unmodified, and the current point is added to the unprojected points list according to (S805) to preserve data of the current point.

If the current pixel occupying the pixel position has a larger depth (farther from the sensor), the current point (closer to the sensor) may overwrite (or replace) the current pixel in the SRI at (S806). The existing point (or current pixel) in the SRI may be added to the unprojected points list at (S807).

The replacement decision at (S804) may ensure that the SRI prioritizes the closest points to the sensor (e.g., LiDAR sensor) without discarding valuable data. This is achieved by storing the farthest points in the unprojected list during a single pass through the point list.

In an aspect, the replacement decision at (S804) may prioritize populating the SRI with pixel values close to each other to facilitate subsequent SRI compression steps through a reasonable frequency variation. In an example, the replacement decision may consider pixel values of populated pixels in a geometric vicinity within the SRI. Optimization variants can be devised, from simple ones that use already populated neighboring samples (arranged circularly around the pixel address) to more complex optimizations that re-balance the unprojected sample list after all point cloud points are processed.

Once the unprojected point list has been computed for the point cloud, and in some cases the whole point cloud, it can be advantageous to remove certain entries therein based on the content of one or more of the range images, the source point cloud, and the unprojected point cloud itself. This approach can effectively remove outlier values that are irrelevant to the application (e.g., due to excessive depth), preventing them from hindering the efficient coding of the unprojected points list.

In an example, a mechanism (or algorithm) may compute, for each point of the unprojected point list, a distance to the source point cloud with a KD-tree search. Based on the distance, it is possible to remove points that do not contribute much to a total distance of the point cloud. According to a fixed threshold or according to a total number of points that need to be kept, some points of the unprojected points list can be removed.

In an example, more advanced techniques such as a rate distortion cost computation may be applied to evaluate an impact of each unprojected point on metric (e.g., fidelity or total distance) versus a cost required to code the unprojected point.

Referring to FIG. 6 and FIG. 7, once an unprojected point list has been generated, the unprojected point list may need to be encoded (612). Similarly, once relevant syntax elements have been parsed (702) from the bitstream and before the reverse of the aforementioned process could be applied, the unprojected point list needs to be reconstructed (705). The unprojected points list includes entries with three components, namely X (e.g., azimuth angle) and Y (e.g., elevation angle) coordinate components of the pixel position in the SRI, and a depth value Z (e.g., r (rho)). The numbering ranges of X, Y, and Z can vary with the application. For some applications, binary coding and 32 bits for X and Y, and 16 bits for Z, have been found sufficient. The total number of list entries in the unprojected point list may also vary with the application, and a typical range may be between a few to a few hundreds. As the unprojected point list collects “outlier” points that may not be conveniently covered by the SRI, the values of X, Y, and Z for a given entry in the unprojected point list may not commonly show much correlation between themselves or other entries in the list. With such parameters in mind, devising coding techniques that compress the unprojected point list can be challenging. Further, for many applications, the unprojected point list can be small compared to the packed, filled, and compressed SRI. Thus, even though strong compression is ideal, complex compression mechanisms may offer limited benefit.

In an aspect, the unprojected points list is coded in uncompressed form, such as using binary coded integer values of the entries in the unprojected point list.

In an aspect, a known or newly devised mechanism can be used based on a variable-length code, a Huffman code, an exponential-Golomb code, etc. These codes may encode certain values more efficiently than other codes, which may require application-specific knowledge about the probability distribution of x, y, and z values to use such codes effectively.

In an aspect, more advanced adaptive entropy coding techniques may be used. For example, context-adaptive binary arithmetic coding (CABAC) may be trained and used to encode unprojected point lists which may lead to better coding efficiency than the aforementioned mechanisms, at the expense of additional complexity.

Still referring to FIGS. 6 and 7, creation of the occupancy map (605) may be advantageous because the 2D image (or 2D images) resulting from the previously described conversion (604) may be inherently sparse. Due to the scaling factors, a resolution may be required, and the resolution may exceed a resolution that is required by related 2D image codecs to handle dense range image scenarios. An occupancy map, which may have a same size as the SRI, can use a binary representation to indicate whether a point (e.g., a point in the 3D point cloud) has been projected at a given location (e.g., a position in the SRI). Each point (e.g., a point in the 3D point cloud) in the occupancy map may signify (or indicate) whether a corresponding point (or sample or pixel) exists (1) or does not exist (0) in the spare range image. If the SRI does not present any disturbances brought by subsequent processes (e.g., the packing and filling (608)), the occupancy map may be redundant because the occupancy map may not add significant information. In such cases, the occupancy map may be omitted from the bitstream (603) and replaced by an indication that no occupancy is included. A missing occupancy map, as indicated by the indication, may indicate that all points (or samples or pixels) in the SRI may have relevance, and may be equivalent to a coded occupancy map with all values set to 1.

Packing (608) the SRI using the created occupancy map (605) may involve reorganizing data in the SRI to utilize storage more efficiently by focusing on the occupied points. Using the occupancy map, which samples in the 2D image have corresponding points can be determined. A packed image may be created to include more values from the occupied points (or occupied samples or occupied pixels) and fewer values from the unoccupied points. Various packing algorithms may be applied. For example, occupied pixels may be moved at the beginning of each row or column, occupied pixels may be moved in a raster order, or in a z-scan order, etc. In an aspect of the disclosure, packing may not be required or advantageous. For example, if the SRI is already dense, the packing operation can be as simple as using the unmodified SRI (e.g., the original SRI) as the packed SRI.

Packing (608) may reduce the size of the packed SRI relative to the original SRI by excluding the empty, unoccupied points.

To ensure that the 2D image can be unpacked at the decoder without loss detrimental to the functionality of the overall system, the occupancy map may be advantageously coded (606) in loss-less. In an example, the occupancy map may be coded loss-less profiles of HEVC or VVC. In an example, the occupancy map may be represented in a one-dimensional signal, and encoded using a zip coding, a run length coding, a Context-Adaptive Binary Arithmetic Coding (CABAC), etc.

To increase the efficiency of the image encoder, the unoccupied samples of the packed SRI may be filled (608) with sample data adequate for the design of the image coding mechanism used. In an example, the sample data filled into an unoccupied sample may be based on values of neighboring samples. For example, the unoccupied sample may be filled by copying the value of the closest occupied sample in a scan order. In an example, the unoccupied sample may be filled by more complex padding algorithms, such as seed fill, row and column fill, push/pull, and reverse intra prediction based on the intra prediction technique employed by the image codec, etc. The filling (608) may be executed independently, whether the SRI has been packed or not.

Compression (or coding) (609) of the packed SRI may involve known compression techniques including zip, HEVC, VVC, or neural encoding approaches.

The bitstream (603) format may include, among other items, one or more of (i) the coded (after packing and filling) SRI image bitstream; (ii) a bitstream representing the coded occupancy map; (iii) metadata coded in a suitable format, for example in the form of one or more supplementary enhancement information (SEI) messages, a compressed XML document, or similar; and (iv) information pertaining to unprojected points as already described. Metadata may be extracted (611) from the source point cloud (601) and may be used to steer (or control) certain decoding steps, for example the 2D to 3D conversion (708). Metadata may be extracted as an output by the decoder in a suitable format to control rendering (not depicted). Metadata may serve certain purposes. In an example, the 2D image resolution depends on the angle covered by the LiDAR. In an example, the elevation is needed to set the vertical resolution of the 2D image. In an example, the min and max of the elevation, for which a point can be found, may be signaled in the metadata.

The decoder (700) may perform steps that can be characterized as an inverse of the encoder steps described above. A first step of the decoder (700) is to parse (702) the bitstream (701), such as via demultiplexer of the decoder (700), to extract sub-bitstreams for the packed/filled SRI and the occupancy map, along with the metadata. The sub-bitstream (or second sub-bitstream) of the packed/filled SRI may be decoded (703), such as by a first decoding component of the decoder (700) using a decoding technology responsive to the bitstream format as created by the encoder (600). Similarly, the sub-bitstream (or first sub-bitstream) with the coded occupancy map may be decoded (704), such as by a second decoding component of the decoder (700) using an appropriate decoding technique. Outputs of the decoding (703) and the decoding (704) may be used by unfilling (707) and unpacking (707) mechanisms (or steps) that operate on the decoded SRI and the decoded/unfilled SRI, respectively. For example, the second sub-bitstream is decoded to obtain a processed image, where the processed image is generated by packing and filling the SRI. The processed image may be unfilled, via an unfilling component of the decoder (700), to obtain an unfilled image based on occupancy information of the occupancy map. The unfilled image may be unpacked, via an unpacking component of the decoder (700), to obtain the SRI based on the occupancy information of the occupancy map. The resulting SRI may be converted (708) back into a point cloud, which may take advantage of decoded metadata (706) and decoded (705) unprojected points conveyed in the bitstream (701) and previously parsed (702) sub-bitstreams.

Aspects of the disclosure include techniques for encoding and decoding three-dimensional point clouds, for example LiDAR point-clouds. The encoding process may involve generating one or more 2D representations of a point cloud. A 2D representation can be an image. X and Y coordinates of the image may refer to azimuth and elevation angles of a polar representation of the point cloud, and a sample value in the image may refer to a depth of a point in the point cloud. The depth can be a distance from a coordinate origin or a sensor to the point. To efficiently represent the depth, quantization of calculated depth values may be required.

Compression of sparse point clouds, such as point clouds generated from LiDAR devices, poses a challenge because related techniques may not offer a reasonable balance between compression efficiency and computational complexity. When a 3D point cloud represented in Cartesian coordinates is converted into polar coordinates, the 3D point cloud may be represented by a 2D image of sufficient resolution, where X and Y of the 2D image may represent azimuth and elevation angles, and sample values in the 2D image may be depth values (e.g., r (rho)) of the points in the 3D point cloud. In such a scenario, the X coordinates, the Y coordinate, and the samples values are all floating-point numbers and need to be appropriately rounded to integers before use. Further, it is beneficial to appropriately quantize the depth to reflect application needs. The nature of the quantization needs to be investigated and specified.

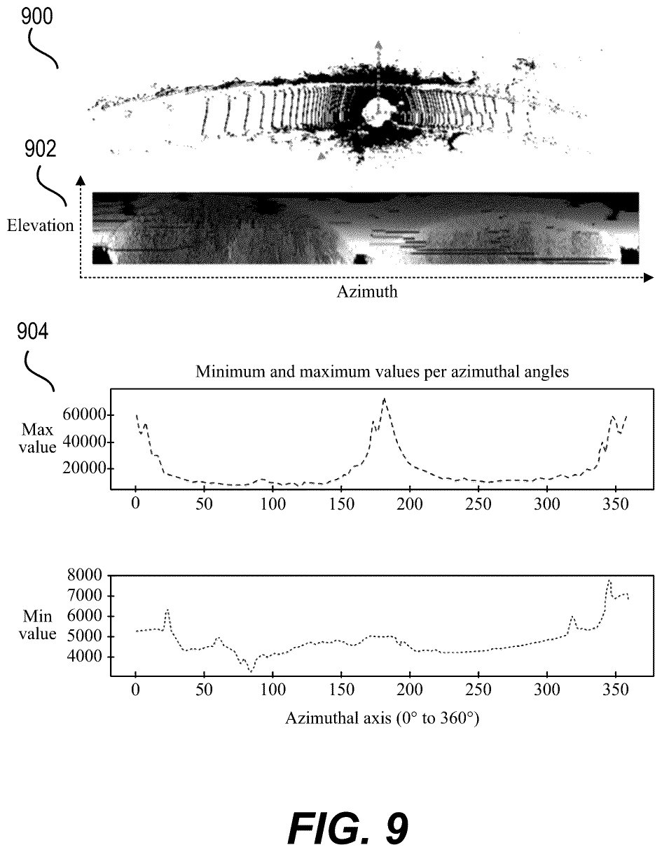

One challenge with the aforementioned mapping is that the distance r of a point cloud sample from a pre-determined point, such as a position of the LiDAR sensor in a space, is coded as a sample value. FIG. 9 shows an example of a point cloud (900) in a 3D space rendered in a 2D space. As shown in a 2D image (902), the point cloud (900) is converted into a polar system representation with azimuth angles on the X axis and elevation angles on the Y axis, with depth (Z axis) values as sample values represented by greyscale. At plots (904), minimum values and maximum Z values corresponding to each azimuth angle value are provided. Depending on the bit depth of the image codec in use, that distance may be limited to 2^{sample depth}. For example, 256 distances correspond to 8 bit sample depth, 1024 distances correspond to 10 sample depth, and so forth. The resulting quantization error may be high for efficient use of the reconstructed point cloud.

In an aspect, the r value is quantized using a vertical band quantization technique.

A vertical band quantization technique may involve dividing the depth image into N vertical bands. The N vertical bands may have an equal size or unequal size. A vertical band may represent a specific vertical section of the depth image that corresponds to a part of the 3D point cloud divided by azimuthal sections. By averaging or selecting representative depth values within each band, the depth image can be effectively quantized, such as based on an average of selected representative depth value in each band, and hence compressed, allowing for faster processing and lower storage requirements. The quantized data can then be encoded using, for example, image or video encoders like JPEG, HEVC or VVC, using moderate bit depth such as 8, 10, or 12 bits, thereby providing efficient storage and transmission.

The minimum and maximum depth values may serve as side information before each vertical band is quantized and hence may need to be encoded in the data stream to allow a correct reverse quantization on a band-by-band basis. With vertical band quantization, if certain regions are closer to the sensor, the quantization can be more effective, as the precision within each band can be adjusted to better capture these variations. Accordingly, the full range of depth information for each band is preserved during compression and reconstruction.

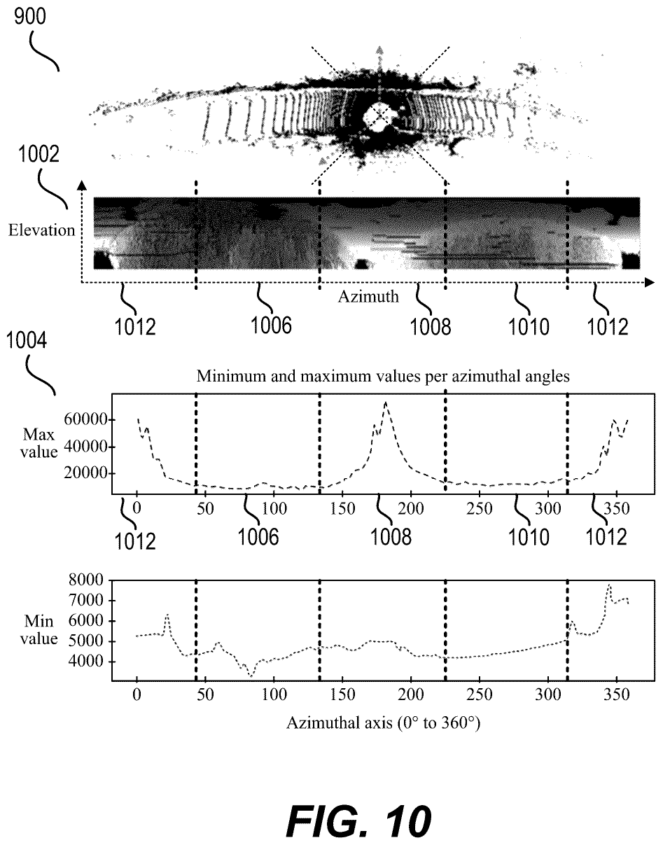

FIG. 10 shows an example of vertical band quantization on a point cloud, such as the point cloud (900) in FIG. 9. As shown in FIG. 10, a 2D image (1002), which is formed by projecting the 3D point cloud into the 2D space, is divided into four vertical bands (1006), (1008), (1010), and (1012). As shown at the plots (1004), the three vertical bands (1006), (1008), and (1010) are shown as continuous, whereas the fourth band (1012) covers azimuth angles between 320 and 40 degrees and hence depicted as two intervals. For the bands (1006) and (1011) between 40 and 130 degrees, and 230 and 320 degrees, a numbering range of minimum and maximum depth values are greatly reduced compared to other bands. Accordingly, finer quantization is allowed, and hence more faithful representation of the depth data is obtained.

Aspects of the disclosure include techniques for encoding and decoding three-dimensional point clouds, for example LiDAR point-clouds. The encoding process may involve generating one or more 2D representations of a point cloud. While models are known for a 3D Cartesian to 2D+value polar conversion, those models can be improved by techniques that consider side information about the source point cloud, such as positions of multiple sensor sources. The side information, or information derived from the side information, may be used to convert 2D+value (e.g., 2D image) back to 3D conversion.

Compression of sparse point clouds, for example point cloud stemming from LiDAR devices, poses a challenge because related techniques may not offer a reasonable balance between compression efficiency and computational complexity. A technique disclosed herein involves conversion of the 3D point cloud in Cartesian coordinates, side information of sensor positions, and other data to a polar coordinate representation arranged in a 2D format. The 2D format may include azimuth angles and elevation angles at X and Y coordinates, and depth (e.g., distance from polar coordinate origin) values of the 3D point cloud as sample values of the 2D image. Techniques are needed to improve such a mapping when the source point cloud was acquired through multiple sensors by considering positions of the multiple sensors and the side information. When an encoding system applies such a mapping, a decoding system may advantageously reverse such a mapping to recover the original point cloud.

The aforementioned mapping may be appropriate if a position of a LiDAR sensor coincides with an origin of a polar coordinate system. However, point clouds may be acquired from multiple sensors, for example from multiple LiDAR sensors. Not all but at most one of the positions of the multiple sensors may necessarily not coincide with the origin of the polar coordinate system. If the generation of the point cloud in Cartesian coordinates was performed correctly, the point cloud should reflect sensor returns (or return information) of all sensors accurately. However, each sensor may measure a different distance to a given point in the point cloud, leading to varying return accuracy among sensors. Assuming the azimuth and elevation angles are quantized (which is necessary for 3D-to-2D conversion to create an integer pixel address), the angular quantization error may be smaller for sensors closer to the point. Finally, the capture angle of sensors may differ for a given point in the space, which has implications since LiDAR relies on laser light reflecting back to the sensor. These are just three intuitive scenarios demonstrating the advantage of considering the sensor positions used to acquire the point cloud.

In an aspect, a LiDAR acquisition system may be characterized by three parameters: a total number of lasers, an angle of one of the lasers that captures a line of points (lasers_theta), and a height of the one of the lasers that captures the line of the points (lasers_z).

In an aspect, an iterative correction mechanism (or process) may be used to enhance accuracy of projecting a 3D point cloud onto a 2D range image based on side information that includes the above three parameters. In an aspect, calibration adjustments may also be applied through multiple iterations.

Initially, vertical angles of points in the 3D point cloud may be calculated using an arctangent of a z-coordinate over a horizontal distance (e.g., Euclidean norm of the x and y coordinates). However, due to sensor imperfections and misalignments, raw measurements of the x, y, and z coordinates may not align perfectly with calibrated sensor readings. To address such a misalignment, calibration data may be employed, such as arrays containing calibrated vertical angles (lasers_theta) and z-coordinate offsets (lasers_z).

In a first step of the iterative process, differences between measured vertical angles and calibrated vertical angles for some or all points are calculated. Initial row indices in the range image (SRI) may be determined by finding a calibrated vertical angle that minimizes the difference for each point. The initial row indices may correspond to the vertical positions (rows) in the 2D image to which the points are projected.

After initialization, a loop may iteratively refine the vertical angles and row indices. In each iteration, the z-coordinates of the points may be adjusted by adding the calibration offsets corresponding to current row indices of the calibration offsets. The adjustment aims to correct any vertical displacement caused by sensor calibration errors. Based on the updated z-coordinates, the vertical angles may be recalculated. From the recalculation data, the differences between these updated vertical angles and the calibrated angles can be derived. By identifying the minimal differences, the row indices may be updated to better align with the calibrated sensor measurements.

The above iterative adjustment may be exercised for a pre-determined number of iterations (e.g., 10 times), thereby the vertical alignment of the points can be progressively refined in the range image. The pre-determined number of iterations may be adjusted to a desired accuracy while respecting computational complexity constraints. The iterations may help converge on the most accurate representation of the 3D environment in a 2D space by compensating for systematic errors in the sensor data.

As an alternative to a pre-determined number of iterations, adaptive criteria may also be used, for example if a high accuracy is desired and computational complexity is not a concern. For example, the iteration may continue until for all, or a pre-determined (e.g., a presumably large number) number of points, between two iterations, no more refinement is observable. Another alternative may be that cumulative refinement errors observed between two iterations becomes smaller than a pre-defined margin. Other, similar adaptive techniques can also be devised. Further, in the above conditions to terminate the iterative process, a system may consider a relative importance of each point when the refinement error is calculated. For example, in a LiDAR system optimized for car parking, points close to each sensor may be more relevant than points far away from the sensors. Conversely, for LiDAR in another application, points at distances in another effective range may be more relevant. Accordingly, refinement errors of the points in the effective range can be advantageously reduced before addressing other points.

In a final step, the calibration offsets may be applied to the z-coordinates one last time, ensuring that the points are correctly positioned vertically.

By focusing on the vertical alignment, the iterative mechanism (or process) described above may significantly improve the fidelity of the range image. It may ensure that each point in the 3D space is accurately mapped to a corresponding position in the 2D image, which could be crucial for applications requiring precise depth information, such as autonomous navigation, obstacle detection, and 3D reconstruction. The iterative nature of the mechanism allows for gradual convergence towards the most accurate solution, more effectively minimizing the impact of calibration discrepancies.

The above description can be illustrated by a simplified example. Consider a LiDAR system including five lasers. The five lasers have calibrated vertical angles i={2°, 5°, 10°, 15°, 20°}, and z-coordinate offsets zi={0.1, 0.15, 0.2, 0.25, 0.3}, respectively.

A 3D point is captured at coordinates (x, y, z)=(10, 0, 1). An initially measured vertical angle may be calculated by □measured=arctan (z/\sqrt{x²+y²}). Thus, the □measured of the 3D point is equal to arctan ( 1/10)≈5.71°. The measured vertical angle is compared to the calibrated vertical angle i values and 5° is found to be closest calibrated vertical angle. A row index of a second laser is assigned (or selected). During iteration, the z-coordinate of the 3D point is adjusted as znew by adding a corresponding offset zi indicated by the row index of the second laser: znew=z+zi=1 m+0.15 m=1.15 m. Accordingly, the coordinates of the 3D point are updated as (10, 0, 1.15)). □measured may be recalculated based on the new coordinates (10, 0, 1.15), such as □measured=arctan ( 1.15/10)≈6.56°. In an aspect, the row index of each laser may remain the same if the closest laser does not change. After the adjustment of the vertical angle of the 3D point, another i becomes closer, the row index is updated accordingly to the other i that becomes closer. The znew is further updated based on the zi corresponding to the new row index. The iteration process may repeat until convergence is reached. For example, the iteration process of the current example may end when the calibration towards the laser with i=10°, which ensures that the 3D point is correctly aligned with the calibrated data.

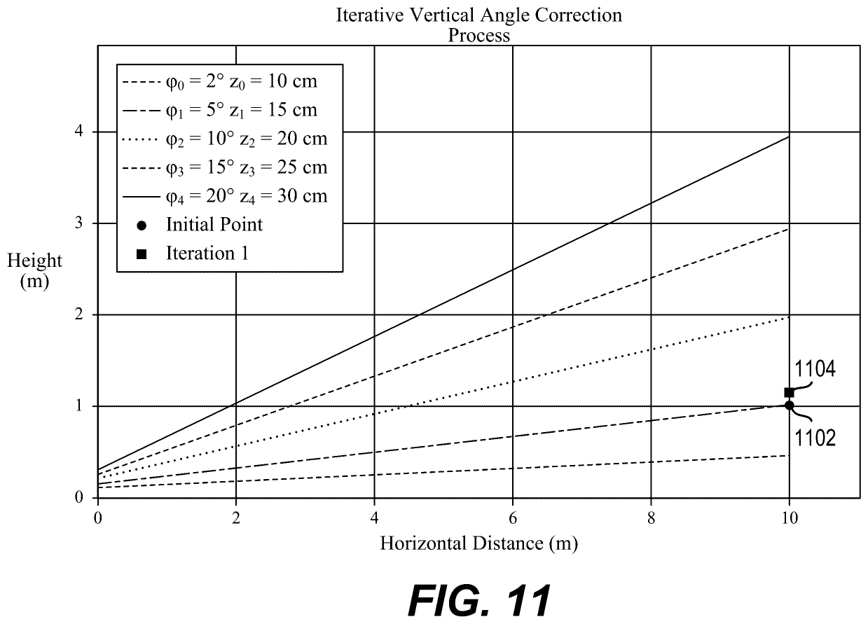

The aforementioned algorithm (or refinement algorithm) enhances the accuracy of projecting the 3D point cloud onto the 2D image by compensating for sensor errors through iterative adjustments of z-coordinates and vertical angles. FIG. 11 shows an iteration process based on the example mentioned above in which the corrected point is finally projected in the range image. As shown in FIG. 11, the 3D point has a z coordinate (1102) of 1 and a new (or updated) z coordinate (1104) of 1.15 after the iteration 1 (or the first iteration).

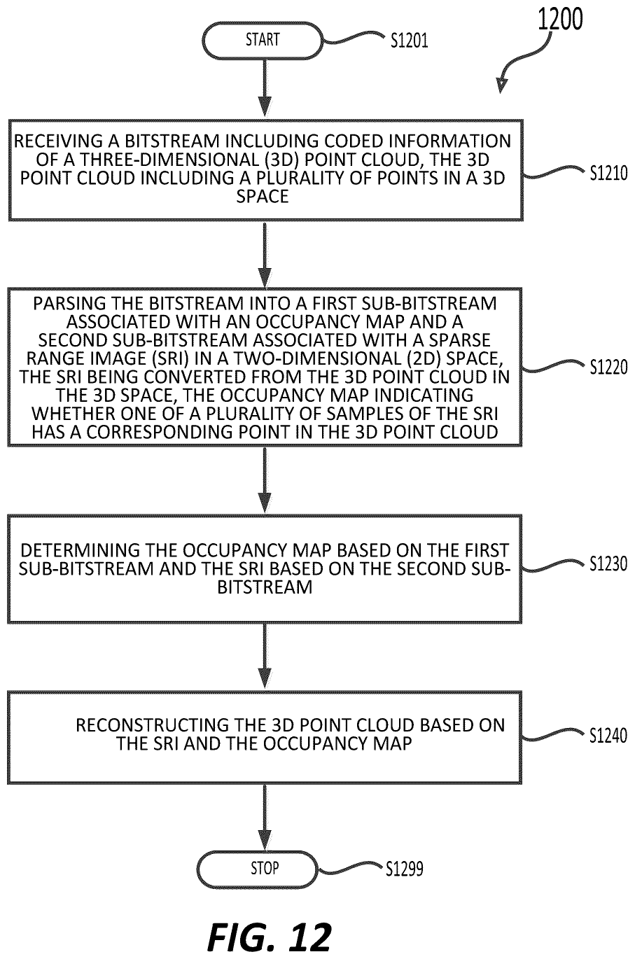

FIG. 12 shows a flow chart outlining a process (1200) according to an aspect of the disclosure. The process (1200) can be used in a decoder. In various aspects, the process (1200) is executed by processing circuitry, such as the processing circuitry that performs functions of the decoder (200B), the processing circuitry that performs functions of the decoder (700), and the like. In some aspects, the process (1200) is implemented in software instructions, thus when the processing circuitry executes the software instructions, the processing circuitry performs the process (1200). The process starts at (S1201) and proceeds to (S1210).

At (S1210), a bitstream including coded information of a 3D point cloud is received. The 3D point cloud includes a plurality of points in a 3D space.

At (S1220), the bitstream is parsed into a first sub-bitstream associated with an occupancy map and a second sub-bitstream associated with a SRI in a 2D space. The SRI is converted from the 3D point cloud in the 3D space. The occupancy map indicates whether one of a plurality of samples of the SRI has a corresponding point in the 3D point cloud.

At (S1230), the occupancy map is determined based on the first sub-bitstream and the SRI based on the second sub-bitstream.

At (S1240), the 3D point cloud is reconstructed based on the SRI and the occupancy map.

In an aspect, the second sub-bitstream is decoded to obtain a processed image. The processed image is generated by packing and filling the SRI. The processed image is unfilled to obtain an unfilled image based on occupancy information of the occupancy map. The unfilled image is unpacked to obtain the SRI based on the occupancy information of the occupancy map.

In an aspect, the plurality of points of the 3D point cloud is reconstructed based on a conversion of the plurality of samples of the SRI from spherical coordinates to cartesian coordinates.

In an aspect, the SRI is packed based on occupancy information of the occupancy map to obtain a packed SRI by excluding one or more unoccupied samples of the SRI that do not have corresponding points in the 3D point cloud, and the packed SRI is filled to obtain a filled SRI by filling one or more unoccupied samples of the packed SRI based on neighboring occupied samples of the packed SRI.

In an aspect, the bitstream parsed into a third sub-bitstream associated with metadata of a plurality of decoding steps. The metadata is extracted from the 3D point cloud.

In an aspect, distance values of the plurality of samples of the SRI are dequantized based on one of (i) a linear scaling in which a highest distance value of the distance values of the plurality of samples is determined according to a bit depth value and (ii) a non-linear scaling in which the distance values of the plurality of samples of the SRI are scaled based on a non-linear algorithm. Each of the distance values indicates a distance between a respective sample of the SRI to a sensor configured to generate the plurality of points of the 3D point cloud.

In an aspect, distance values of the plurality of samples of the SRI are divided into a plurality of scales, and samples in each of the plurality of scales are quantized based on a respective linear scaling.

In an aspect, each of the plurality of samples in the SRI includes a respective distance value indicating a distance between the respective sample to a sensor configured to generate the plurality of points of the 3D point cloud, a respective azimuth angle value, and a respective elevation angle value. The SRI includes a plurality of sub-2D images that is categorized by one or a combination of the distance values, the azimuth angle values, and the elevation angle values of the plurality of samples of the SRI. The determining the SRI further includes dequantizing each of the plurality of sub-2D images based on one of a linear scaling and a non-linear scaling.

In an aspect, when two or more points of the plurality of points of the 3D point cloud correspond to a same pixel position in the SRI with a same azimuth angle value and a same elevation angle value, one of the two or more points of the 3D point cloud that has a smallest distance value to a pre-defined position is selected as a projected point to the SRI, and other points of the two or more points of the 3D point cloud are included in an unprojected point list. The unprojected point list includes a plurality of unprojected points with respect to the SRI.

In an aspect, when a current point of the 3D point cloud corresponds to an unoccupied pixel position in the SRI, the current point is assigned to the unoccupied pixel position in the SRI. When (i) the current point of the 3D point cloud corresponds to an occupied pixel position in the SRI, and (ii) a distance value of the current point with respect to a pre-defined position is smaller than a distance value of a pixel in the occupied pixel position with respect to the pre-defined position, the pixel in the occupied pixel position is replaced by the current point. When (i) the current point of the 3D point cloud corresponds to the occupied pixel position in the SRI, and (ii) the distance value of the current point with respect to the pre-defined position is larger than the distance value of the pixel in the occupied pixel position with respect to the pre-defined position, the current point is assigned to an unprojected point list.

In an aspect, whether a pixel in an occupied pixel position of the SRI is replaced by a current point of the 3D point cloud is based on which one of the pixel in the occupied pixel position and the current point is closer to neighboring pixels of the SRI.

In an aspect, which one of the plurality of unprojected points in the unprojected point list is not coded is determined based on one of (i) a contribution of the one of the plurality of unprojected points to a total distance, and (ii) a rate distortion cost calculated according to an impact of the one of the plurality of unprojected points and a coding cost to code the one of the plurality of unprojected points.

In an aspect, each of the plurality of samples in the SRI includes a respective distance value indicating a distance between the respective sample to a sensor configured to generate the plurality of points of the 3D point cloud, a respective azimuth angle value, and a respective elevation angle value. The plurality of sub-2D images is categorized by respective ranges of the azimuth angle values of the plurality of samples of the SRI. A minimum depth value and a maximum depth value associated with each of the plurality of sub-2D images are decoded. Each of the plurality of sub-2D images is dequantized based on (i) a representative depth value of the respective one of the plurality of sub-2D images, and (ii) the minimum depth value and the maximum depth value associated with the respective one of the plurality of sub-2D images.

In an aspect, the plurality of points of the 3D point cloud is captured by a plurality of sensors, and each of the plurality of sensors is associated with a respective calibrated vertical angle and a respective z-coordinate offset.

In an aspect, horizontal coordinates, vertical coordinates, and depth coordinates of the plurality of points of the 3D point cloud are determined based on spherical coordinates of the plurality of samples of the SRI. A vertical angle of a current point of the 3D point cloud is calculated based on an arc tangent of a depth coordinate of the current point over a horizontal distance of the current point. The horizontal distance is a Euclidean norm of a horizontal coordinate and a vertical coordinate of the current point. Which one of the calibrated vertical angles of the plurality of sensors is closest to the vertical angle of the current point is determined. According to a pre-set condition, the vertical coordinate of the current point is updated by adding a z-coordinate offset that corresponds to the one of the calibrated vertical angles that is close to the vertical angle of the current point.

In an aspect, the pre-set condition includes one of a total updating number is less than a pre-defined value, and a difference between the one of the calibrated vertical angles and the vertical angle of the current point is larger than a pre-defined margin.

Then, the process proceeds to (S1299) and terminates.

The process (1200) can be suitably adapted. Step(s) in the process (1200) can be modified and/or omitted. Additional step(s) can be added. Any suitable order of implementation can be used.

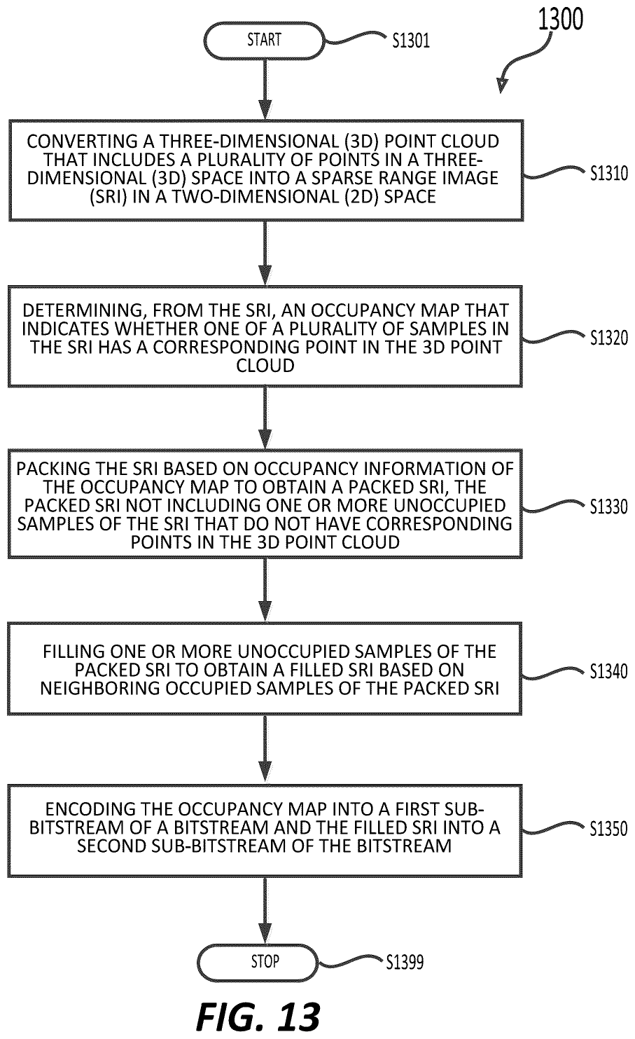

FIG. 13 shows a flow chart outlining a process (1300) according to an aspect of the disclosure. The process (1300) can be used in an encoder. In various aspects, the process (1300) is executed by processing circuitry, such as the processing circuitry that performs functions of the encoder (200A), the processing circuitry that performs functions of the encoder (600), and the like. In some aspects, the process (1300) is implemented in software instructions, thus when the processing circuitry executes the software instructions, the processing circuitry performs the process (1300). The process starts at (S1301) and proceeds to (S1310).

At (S1310), a 3D point cloud that includes a plurality of points in a 3D space is converted into a SRI in a 2D space.

At (S1320), from the SRI, an occupancy map is determined. The occupancy map indicates whether one of a plurality of samples in the SRI has a corresponding point in the 3D point cloud.

At (S1330), the SRI is packed based on occupancy information of the occupancy map to obtain a packed SRI. The packed SRI does not include one or more unoccupied samples of the SRI that do not have corresponding points in the 3D point cloud.

At (S1340), one or more unoccupied samples of the packed SRI are filled to obtain a filled SRI based on neighboring occupied samples of the packed SRI.

At (S1350), the occupancy map is encoded into a first sub-bitstream of a bitstream and the filled SRI is encoded into a second sub-bitstream of the bitstream.

In an aspect, distance values of samples of the filled SRI are quantized based on one of (i) a linear scaling in which a highest distance value of the distance values of the samples is determined according to a bit depth value and (ii) a non-linear scaling in which the distance values of the samples of the filled SRI are scaled based on a non-linear algorithm. Each of the distance values indicates a distance between a respective sample of the filled SRI to a sensor configured to generate the plurality of points of the 3D point cloud.

In an aspect, when two or more points of the plurality of points of the 3D point cloud correspond to a same pixel position in the SRI with a same azimuth angle value and a same elevation angle value, one of the two or more points of the 3D point cloud that has a smallest distance value to a pre-defined position is selected as a projected point to the SRI, and other points of the two or more points of the 3D point cloud are included in an unprojected point list. The unprojected point list includes a plurality of unprojected points with respect to the SRI.

Then, the process proceeds to (S1399) and terminates.

The process (1300) can be suitably adapted. Step(s) in the process (1300) can be modified and/or omitted. Additional step(s) can be added. Any suitable order of implementation can be used.

According to another aspect of the disclosure, a non-transitory computer-readable storage medium storing a bitstream that is generated by an encoding method is provided. In the encoding method, a 3D point cloud that includes a plurality of points in a 3D space is converted into a SRI in a 2D space. An occupancy map is determined from the SRI. The occupancy map indicates whether one of a plurality of samples in the SRI has a corresponding point in the 3D point cloud. The SRI is packed based on occupancy information of the occupancy map to obtain a packed SRI. The packed SRI does not include one or more unoccupied samples of the SRI that do not have corresponding points in the 3D point cloud. One or more unoccupied samples of the packed SRI are filled to obtain a filled SRI based on neighboring occupied samples of the packed SRI. The occupancy map is encoded into a first sub-bitstream of a bitstream and the filled SRI is encoded into a second sub-bitstream of the bitstream.

According to another aspect of the disclosure a non-transitory computer-readable storage medium storing a bitstream that when processed by a processor cause the processor to perform point cloud decoding. The point cloud decoding is performed in accordance with a format rule for example. The bitstream includes coded information of a three-dimensional (3D) point cloud. The format rule specifies that the 3D point cloud includes a plurality of points in a 3D space. The format rule specifies that the bitstream is parsed into a first sub-bitstream associated with an occupancy map and a second sub-bitstream associated with a sparse range image (SRI) in a two-dimensional (2D) space. The format rules specifies that the SRI is converted from the 3D point cloud in the 3D space. The occupancy map indicates whether one of a plurality of samples of the SRI has a corresponding point in the 3D point cloud. The format rule specifies that the occupancy map is determined based on the first sub-bitstream and the SRI based on the second sub-bitstream. The format rule specifies that the 3D point cloud is reconstructed based on the SRI and the occupancy map.

According to another aspect of the disclosure, a method of processing three-dimensional (3D) point cloud data is provided. In the method, a bitstream that includes coded information of the 3D point cloud is processed according to a format rule. The format rule specifies that the 3D point cloud includes a plurality of points in a 3D space. The format rule specifies that the bitstream is parsed into a first sub-bitstream associated with an occupancy map and a second sub-bitstream associated with a sparse range image (SRI) in a two-dimensional (2D) space. The format rules specifies that the SRI is converted from the 3D point cloud in the 3D space. The occupancy map indicates whether one of a plurality of samples of the SRI has a corresponding point in the 3D point cloud. The format rule specifies that the occupancy map is determined based on the first sub-bitstream and the SRI based on the second sub-bitstream. The format rule specifies that the 3D point cloud is reconstructed based on the SRI and the occupancy map.

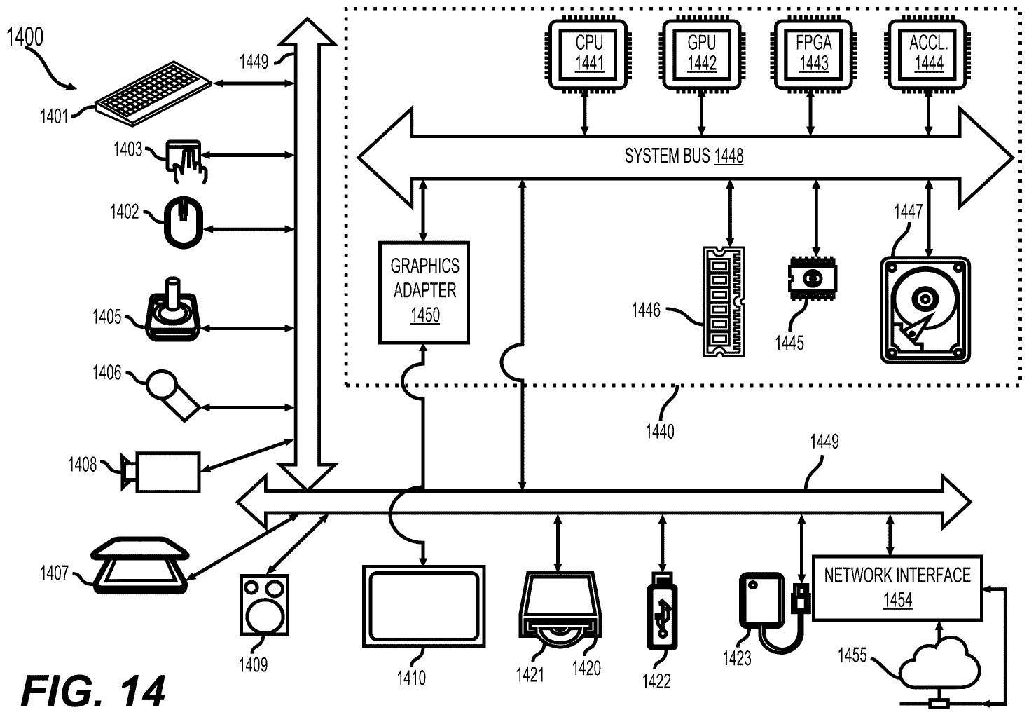

The techniques described above, can be implemented as computer software using computer-readable instructions and physically stored in one or more computer-readable media. For example, FIG. 14 shows a computer system (1400) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 14 for computer system (1400) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1400).

Computer system (1400) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video), and point cloud (such as LiDAR point cloud).

Input human interface devices may include one or more of (only one of each depicted): keyboard (1401), mouse (1402), trackpad (1403), touch screen (1410), data-glove (not shown), joystick (1405), microphone (1406), scanner (1407), camera (1408).

Computer system (1400) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1410), data-glove (not shown), or joystick (1405), but there can also be tactile feedback devices that do not serve as input devices), audio output devices (such as: speakers (1409), headphones (not depicted)), visual output devices (such as screens (1410) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (1400) can also include human accessible storage devices and their associated media such as optical media including CD/DVD ROM/RW (1420) with CD/DVD or the like media (1421), thumb-drive (1422), removable hard drive or solid state drive (1423), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1400) can also include an interface (1454) to one or more communication networks (1455). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1449) (such as, for example USB ports of the computer system (1400)); others are commonly integrated into the core of the computer system (1400) by attachment to a system bus as described below (for example Ethernet interface into a PC computer system or cellular network interface into a smartphone computer system). Using any of these networks, computer system (1400) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1440) of the computer system (1400).

The core (1440) can include one or more Central Processing Units (CPU) (1441), Graphics Processing Units (GPU) (1442), specialized programmable processing units in the form of Field Programmable Gate Areas (FPGA) (1443), hardware accelerators for certain tasks (1444), graphics adapters (1450), and so forth. These devices, along with Read-only memory (ROM) (1445), Random-access memory (1446), internal mass storage such as internal non-user accessible hard drives, SSDs, and the like (1447), may be connected through a system bus (1448). In some computer systems, the system bus (1448) can be accessible in the form of one or more physical plugs to enable extensions by additional CPUs, GPU, and the like. The peripheral devices can be attached either directly to the core's system bus (1448), or through a peripheral bus (1449). In an example, the screen (1410) can be connected to the graphics adapter (1450). Architectures for a peripheral bus include PCI, USB, and the like.

CPUs (1441), GPUs (1442), FPGAs (1443), and accelerators (1444) can execute certain instructions that, in combination, can make up the aforementioned computer code. That computer code can be stored in ROM (1445) or RAM (1446). Transitional data can also be stored in RAM (1446), whereas permanent data can be stored for example, in the internal mass storage (1447). Fast storage and retrieve to any of the memory devices can be enabled through the use of cache memory, that can be closely associated with one or more CPU (1441), GPU (1442), mass storage (1447), ROM (1445), RAM (1446), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1400), and specifically the core (1440) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1440) that are of non-transitory nature, such as core-internal mass storage (1447) or ROM (1445). The software implementing various aspects of the present disclosure can be stored in such devices and executed by core (1440). A computer-readable medium can include one or more memory devices or chips, according to particular needs. The software can cause the core (1440) and specifically the processors therein (including CPU, GPU, FPGA, and the like) to execute particular processes or particular parts of particular processes described herein, including defining data structures stored in RAM (1446) and modifying such data structures according to the processes defined by the software. In addition or as an alternative, the computer system can provide functionality as a result of logic hardwired or otherwise embodied in a circuit (for example: accelerator (1444)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The techniques disclosed may be used separately or combined in any order. Further, for each of the techniques, encoder, and decoder may be implemented by processing circuitry (e.g., one or more processors or one or more integrated circuits). In one example, the one or more processors execute a program that is stored in a non-transitory computer-readable medium.

The above disclosed techniques can be implemented in an image and/or video decoding process or an image and/or video encoding process. The decoding/encoding process can be used in a video decoder device. Additionally, the decoding/encoding process can also be used in a video encoder device. In some embodiments, the process is executed by processing circuitry, such as the processing circuitry that performs functions of the video decoder, the processing circuitry that performs functions of the video decoder, and the like. In other embodiments, the process is executed by processing circuitry, such as the processing circuitry that performs functions of the video encoder, the processing circuitry that performs functions of the video encoder, and the like. In some embodiments, the process is implemented in software instructions, thus when the processing circuitry executes the software instructions, the processing circuitry performs the process. In other embodiments, the process can be implemented on the chip as a hardware process, thus when the processing circuitry executes the hardware instructions, the processing circuitry performs the process. The process can be suitably adapted. Steps in the process as described above can be modified and/or omitted. Additional steps can be added. Any suitable order of implementation can be used.

The techniques described above, can be implemented as computer software using computer-readable instructions and physically stored in one or more computer-readable media. For example, a computer system can be suitable for implementing certain embodiments of the disclosed subject matter. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like. The instructions can be executed on various types of computers or components thereof, including, for example, personal computers, tablet computers, servers, smartphones, gaming devices, internet of things devices, and the like. The components for computer system are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Those skilled in the art should also understand that term “computer readable media” as used in connection with the presently disclosed subject matter does not encompass transmission media, carrier waves, or other transitory signals.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method of point cloud decoding, the method including: receiving a bitstream including coded information of a three-dimensional (3D) point cloud, the 3D point cloud including a plurality of points in a 3D space; parsing the bitstream into a first sub-bitstream associated with an occupancy map and a second sub-bitstream associated with a sparse range image (SRI) in a two-dimensional (2D) space, the SRI being converted from the 3D point cloud in the 3D space, the occupancy map indicating whether one of a plurality of samples of the SRI has a corresponding point in the 3D point cloud; determining the occupancy map based on the first sub-bitstream and the SRI based on the second sub-bitstream; and reconstructing the 3D point cloud based on the SRI and the occupancy map.
(2) The method of feature (1), in which the determining the SRI further includes: decoding the second sub-bitstream to obtain a processed image, the processed image being generated by packing and filling the SRI; unfilling the processed image to obtain an unfilled image based on occupancy information of the occupancy map; and unpacking the unfilled image to obtain the SRI based on the occupancy information of the occupancy map.
(3) The method of features (1) or (2), in which the reconstructing the 3D point cloud further includes: reconstructing the plurality of points of the 3D point cloud based on a conversion of the plurality of samples of the SRI from spherical coordinates to cartesian coordinates.
(4) The method of any one of features (1) to (3), in which: the SRI is packed based on occupancy information of the occupancy map to obtain a packed SRI by excluding one or more unoccupied samples of the SRI that do not have corresponding points in the 3D point cloud, and the packed SRI is filled to obtain a filled SRI by filling one or more unoccupied samples of the packed SRI based on neighboring occupied samples of the packed SRI.
(5) The method of any one of features (1) to (4), in which the parsing further includes: parsing the bitstream into a third sub-bitstream associated with metadata of a plurality of decoding steps, the metadata being extracted from the 3D point cloud.
(6) The method of any one of features (1) to (5), in which the determining the SRI further includes: dequantizing distance values of the plurality of samples of the SRI based on one of (i) a linear scaling in which a highest distance value of the distance values of the plurality of samples is determined according to a bit depth value and (ii) a non-linear scaling in which the distance values of the plurality of samples of the SRI are scaled based on a non-linear algorithm, each of the distance values indicating a distance between a respective sample of the SRI to a sensor configured to generate the plurality of points of the 3D point cloud.
(7) The method of any one of features (1) to (6), in which: distance values of the plurality of samples of the SRI are divided into a plurality of scales, and samples in each of the plurality of scales are quantized based on a respective linear scaling.
(8) The method of any one of features (1) to (7), in which: each of the plurality of samples in the SRI includes a respective distance value indicating a distance between the respective sample to a sensor configured to generate the plurality of points of the 3D point cloud, a respective azimuth angle value, and a respective elevation angle value, the SRI includes a plurality of sub-2D images that is categorized by one or a combination of the distance values, the azimuth angle values, and the elevation angle values of the plurality of samples of the SRI, and the determining the SRI further includes dequantizing each of the plurality of sub-2D images based on one of a linear scaling and a non-linear scaling.
(9) The method of any one of features (1) to (8), in which: when two or more points of the plurality of points of the 3D point cloud correspond to a same pixel position in the SRI with a same azimuth angle value and a same elevation angle value, one of the two or more points of the 3D point cloud that has a smallest distance value to a pre-defined position is selected as a projected point to the SRI, and other points of the two or more points of the 3D point cloud are included in an unprojected point list, the unprojected point list including a plurality of unprojected points with respect to the SRI.
(10) The method of any one of features (1) to (9), in which: when a current point of the 3D point cloud corresponds to an unoccupied pixel position in the SRI, the current point is assigned to the unoccupied pixel position in the SRI, when (i) the current point of the 3D point cloud corresponds to an occupied pixel position in the SRI, and (ii) a distance value of the current point with respect to a pre-defined position is smaller than a distance value of a pixel in the occupied pixel position with respect to the pre-defined position, the pixel in the occupied pixel position is replaced by the current point, and when (i) the current point of the 3D point cloud corresponds to the occupied pixel position in the SRI, and (ii) the distance value of the current point with respect to the pre-defined position is larger than the distance value of the pixel in the occupied pixel position with respect to the pre-defined position, the current point is assigned to an unprojected point list.
(11) The method of any one of features (1) to (10), in which: whether a pixel in an occupied pixel position of the SRI is replaced by a current point of the 3D point cloud is based on which one of the pixel in the occupied pixel position and the current point is closer to neighboring pixels of the SRI.
(12) The method of feature (9), further including: determining which one of the plurality of unprojected points in the unprojected point list is not coded based on one of (i) a contribution of the one of the plurality of unprojected points to a total distance, and (ii) a rate distortion cost calculated according to an impact of the one of the plurality of unprojected points and a coding cost to code the one of the plurality of unprojected points.
(13) The method of feature (8), in which: each of the plurality of samples in the SRI includes a respective distance value indicating a distance between the respective sample to a sensor configured to generate the plurality of points of the 3D point cloud, a respective azimuth angle value, and a respective elevation angle value, the plurality of sub-2D images is categorized by respective ranges of the azimuth angle values of the plurality of samples of the SRI; and the determining the SRI further comprises: decoding a minimum depth value and a maximum depth value associated with each of the plurality of sub-2D images; and dequantizing each of the plurality of sub-2D images based on (i) a representative depth value of the respective one of the plurality of sub-2D images, and (ii) the minimum depth value and the maximum depth value associated with the respective one of the plurality of sub-2D images.
(14) The method of any one of features (1) to (13), in which: the plurality of points of the 3D point cloud is captured by a plurality of sensors, and each of the plurality of sensors is associated with a respective calibrated vertical angle and a respective z-coordinate offset.
(15) The method of feature (14), in which the reconstructing the 3D point cloud further includes: determining horizontal coordinates, vertical coordinates, and depth coordinates of the plurality of points of the 3D point cloud based on spherical coordinates of the plurality of samples of the SRI; calculating a vertical angle of a current point of the 3D point cloud based on an arc tangent of a depth coordinate of the current point over a horizontal distance of the current point, the horizontal distance being an Euclidean norm of a horizontal coordinate and a vertical coordinate of the current point; determining which one of the calibrated vertical angles of the plurality of sensors is closest to the vertical angle of the current point; and updating, according to a pre-set condition, the vertical coordinate of the current point by adding a z-coordinate offset that corresponds to the one of the calibrated vertical angles that is close to the vertical angle of the current point.
(16) The method of feature (15), in which the pre-set condition includes one of: a total updating number is less than a pre-defined value, and a difference between the one of the calibrated vertical angles and the vertical angle of the current point is larger than a pre-defined margin.
(17) A method of point cloud encoding, the method including: converting a three-dimensional (3D) point cloud that includes a plurality of points in a three-dimensional (3D) space into a sparse range image (SRI) in a two-dimensional (2D) space; determining, from the SRI, an occupancy map that indicates whether one of a plurality of samples in the SRI has a corresponding point in the 3D point cloud; packing the SRI based on occupancy information of the occupancy map to obtain a packed SRI, the packed SRI not including one or more unoccupied samples of the SRI that do not have corresponding points in the 3D point cloud; filling one or more unoccupied samples of the packed SRI to obtain a filled SRI based on neighboring occupied samples of the packed SRI; and encoding the occupancy map into a first sub-bitstream of a bitstream and the filled SRI into a second sub-bitstream of the bitstream.
(18) The method of feature (17), in which the encoding further includes: quantizing distance values of samples of the filled SRI based on one of (i) a linear scaling in which a highest distance value of the distance values of the samples is determined according to a bit depth value and (ii) a non-linear scaling in which the distance values of the samples of the filled SRI are scaled based on a non-linear algorithm, each of the distance values indicating a distance between a respective sample of the filled SRI to a sensor configured to generate the plurality of points of the 3D point cloud.
(19) The method of features (17) or (18), in which the converting further includes: when two or more points of the plurality of points of the 3D point cloud correspond to a same pixel position in the SRI with a same azimuth angle value and a same elevation angle value, one of the two or more points of the 3D point cloud that has a smallest distance value to a pre-defined position is selected as a projected point to the SRI, and other points of the two or more points of the 3D point cloud are included in an unprojected point list, the unprojected point list including a plurality of unprojected points with respect to the SRI.
(20) A non-transitory computer-readable storage medium storing a bitstream that is generated by an encoding method, the encoding method including: converting a three-dimensional (3D) point cloud that includes a plurality of points in a three-dimensional (3D) space into a sparse range image (SRI) in a two-dimensional (2D) space; determining, from the SRI, an occupancy map that indicates whether one of a plurality of samples in the SRI has a corresponding point in the 3D point cloud; packing the SRI based on occupancy information of the occupancy map to obtain a packed SRI, the packed SRI not including one or more unoccupied samples of the SRI that do not have corresponding points in the 3D point cloud; filling one or more unoccupied samples of the packed SRI to obtain a filled SRI based on neighboring occupied samples of the packed SRI; and encoding the occupancy map into a first sub-bitstream of a bitstream and the filled SRI into a second sub-bitstream of the bitstream.
(21) An apparatus for mesh decoding, including processing circuitry that is configured to perform the method of any of features (1) to (16).
(22) An apparatus for mesh encoding, including processing circuitry that is configured to perform the method of any of features (17) to (19).
(23) A non-transitory computer-readable storage medium storing instructions which when executed by at least one processor cause the at least one processor to perform the method of any of features (1) to (20).

What is claimed is:

1. A method of point cloud decoding, the method comprising:
receiving a bitstream including coded information of a three-dimensional (3D) point cloud, the 3D point cloud including a plurality of points in a 3D space;
parsing the bitstream into a first sub-bitstream associated with an occupancy map and a second sub-bitstream associated with a sparse range image (SRI) in a two-dimensional (2D) space, the SRI being converted from the 3D point cloud in the 3D space, the occupancy map indicating whether one of a plurality of samples of the SRI has a corresponding point in the 3D point cloud;
determining the occupancy map based on the first sub-bitstream and the SRI based on the second sub-bitstream; and
reconstructing the 3D point cloud based on the SRI and the occupancy map.

2. The method of claim 1, wherein the determining the SRI further comprises:
decoding the second sub-bitstream to obtain a processed image, the processed image being generated by packing and filling the SRI;
unfilling the processed image to obtain an unfilled image based on occupancy information of the occupancy map; and
unpacking the unfilled image to obtain the SRI based on the occupancy information of the occupancy map.

3. The method of claim 1, wherein the reconstructing the 3D point cloud further comprises:
reconstructing the plurality of points of the 3D point cloud based on a conversion of the plurality of samples of the SRI from spherical coordinates to cartesian coordinates.

4. The method of claim 1, wherein:
the SRI is packed based on occupancy information of the occupancy map to obtain a packed SRI by excluding one or more unoccupied samples of the SRI that do not have corresponding points in the 3D point cloud, and
the packed SRI is filled to obtain a filled SRI by filling one or more unoccupied samples of the packed SRI based on neighboring occupied samples of the packed SRI.

5. The method of claim 1, wherein the parsing further comprises:
parsing the bitstream into a third sub-bitstream associated with metadata of a plurality of decoding steps, the metadata being extracted from the 3D point cloud.

6. The method of claim 1, wherein the determining the SRI further comprises:
dequantizing distance values of the plurality of samples of the SRI based on one of (i) a linear scaling in which a highest distance value of the distance values of the plurality of samples is determined according to a bit depth value and (ii) a non-linear scaling in which the distance values of the plurality of samples of the SRI are scaled based on a non-linear algorithm, each of the distance values indicating a distance between a respective sample of the SRI to a sensor configured to generate the plurality of points of the 3D point cloud.

7. The method of claim 1, wherein:
distance values of the plurality of samples of the SRI are divided into a plurality of scales, and
samples in each of the plurality of scales are quantized based on a respective linear scaling.

8. The method of claim 1, wherein:
each of the plurality of samples in the SRI includes a respective distance value indicating a distance between the respective sample to a sensor configured to generate the plurality of points of the 3D point cloud, a respective azimuth angle value, and a respective elevation angle value,
the SRI includes a plurality of sub-2D images that is categorized by one or a combination of the distance values, the azimuth angle values, and the elevation angle values of the plurality of samples of the SRI, and
the determining the SRI further includes dequantizing each of the plurality of sub-2D images based on one of a linear scaling and a non-linear scaling.

9. The method of claim 1, wherein:
when two or more points of the plurality of points of the 3D point cloud correspond to a same pixel position in the SRI with a same azimuth angle value and a same elevation angle value,
one of the two or more points of the 3D point cloud that has a smallest distance value to a pre-defined position is selected as a projected point to the SRI, and
other points of the two or more points of the 3D point cloud are included in an unprojected point list, the unprojected point list including a plurality of unprojected points with respect to the SRI.

10. The method of claim 1, wherein:
when a current point of the 3D point cloud corresponds to an unoccupied pixel position in the SRI, the current point is assigned to the unoccupied pixel position in the SRI,
when (i) the current point of the 3D point cloud corresponds to an occupied pixel position in the SRI, and (ii) a distance value of the current point with respect to a pre-defined position is smaller than a distance value of a pixel in the occupied pixel position with respect to the pre-defined position, the pixel in the occupied pixel position is replaced by the current point, and
when (i) the current point of the 3D point cloud corresponds to the occupied pixel position in the SRI, and (ii) the distance value of the current point with respect to the pre-defined position is larger than the distance value of the pixel in the occupied pixel position with respect to the pre-defined position, the current point is assigned to an unprojected point list.

11. The method of claim 1, wherein:
whether a pixel in an occupied pixel position of the SRI is replaced by a current point of the 3D point cloud is based on which one of the pixel in the occupied pixel position and the current point is closer to neighboring pixels of the SRI.

12. The method of claim 9, further comprising:
determining which one of the plurality of unprojected points in the unprojected point list is not coded based on one of (i) a contribution of the one of the plurality of unprojected points to a total distance, and (ii) a rate distortion cost calculated according to an impact of the one of the plurality of unprojected points and a coding cost to code the one of the plurality of unprojected points.

13. The method of claim 8, wherein:
each of the plurality of samples in the SRI includes a respective distance value indicating a distance between the respective sample to a sensor configured to generate the plurality of points of the 3D point cloud, a respective azimuth angle value, and a respective elevation angle value,
the plurality of sub-2D images is categorized by respective ranges of the azimuth angle values of the plurality of samples of the SRI; and
the determining the SRI further comprises:
decoding a minimum depth value and a maximum depth value associated with each of the plurality of sub-2D images; and
dequantizing each of the plurality of sub-2D images based on (i) a representative depth value of the respective one of the plurality of sub-2D images, and (ii) the minimum depth value and the maximum depth value associated with the respective one of the plurality of sub-2D images.

14. The method of claim 1, wherein:
the plurality of points of the 3D point cloud is captured by a plurality of sensors, and
each of the plurality of sensors is associated with a respective calibrated vertical angle and a respective z-coordinate offset.

15. The method of claim 14, wherein the reconstructing the 3D point cloud further comprises:
determining horizontal coordinates, vertical coordinates, and depth coordinates of the plurality of points of the 3D point cloud based on spherical coordinates of the plurality of samples of the SRI;
calculating a vertical angle of a current point of the 3D point cloud based on an arc tangent of a depth coordinate of the current point over a horizontal distance of the current point, the horizontal distance being an Euclidean norm of a horizontal coordinate and a vertical coordinate of the current point;
determining which one of the calibrated vertical angles of the plurality of sensors is closest to the vertical angle of the current point; and
updating, according to a pre-set condition, the vertical coordinate of the current point by adding a z-coordinate offset that corresponds to the one of the calibrated vertical angles that is close to the vertical angle of the current point.

16. The method of claim 15, wherein the pre-set condition includes one of:
a total updating number is less than a pre-defined value, and
a difference between the one of the calibrated vertical angles and the vertical angle of the current point is larger than a pre-defined margin.

17. A method of point cloud encoding, the method comprising:
converting a three-dimensional (3D) point cloud that includes a plurality of points in a 3D space into a sparse range image (SRI) in a two-dimensional (2D) space;
determining, from the SRI, an occupancy map that indicates whether one of a plurality of samples in the SRI has a corresponding point in the 3D point cloud;
packing the SRI based on occupancy information of the occupancy map to obtain a packed SRI, the packed SRI not including one or more unoccupied samples of the SRI that do not have corresponding points in the 3D point cloud;
filling one or more unoccupied samples of the packed SRI to obtain a filled SRI based on neighboring occupied samples of the packed SRI; and
encoding the occupancy map into a first sub-bitstream of a bitstream and the filled SRI into a second sub-bitstream of the bitstream.

18. The method of claim 17, wherein the encoding further comprises:
quantizing distance values of samples of the filled SRI based on one of (i) a linear scaling in which a highest distance value of the distance values of the samples is determined according to a bit depth value and (ii) a non-linear scaling in which the distance values of the samples of the filled SRI are scaled based on a non-linear algorithm, each of the distance values indicating a distance between a respective sample of the filled SRI to a sensor configured to generate the plurality of points of the 3D point cloud.

19. The method of claim 17, wherein the converting further comprises:
when two or more points of the plurality of points of the 3D point cloud correspond to a same pixel position in the SRI with a same azimuth angle value and a same elevation angle value,
one of the two or more points of the 3D point cloud that has a smallest distance value to a pre-defined position is selected as a projected point to the SRI, and
other points of the two or more points of the 3D point cloud are included in an unprojected point list, the unprojected point list including a plurality of unprojected points with respect to the SRI.

20. A non-transitory computer readable medium storing a bitstream encoded by an encoding method, the encoding method comprising:
converting a three-dimensional (3D) point cloud that includes a plurality of points in a 3D space into a sparse range image (SRI) in a two-dimensional (2D) space;
determining, from the SRI, an occupancy map that indicates whether one of a plurality of samples in the SRI has a corresponding point in the 3D point cloud;
packing the SRI based on occupancy information of the occupancy map to obtain a packed SRI, the packed SRI not including one or more unoccupied samples of the SRI that do not have corresponding points in the 3D point cloud;
filling one or more unoccupied samples of the packed SRI to obtain a filled SRI based on neighboring occupied samples of the packed SRI; and
encoding the occupancy map into a first sub-bitstream of the bitstream and the filled SRI into a second sub-bitstream of the bitstream.
